(19) United States
(12) Patent Application Publication
(10) Pub. No.: US 2023/0325983 A1
(43) Pub. Date: Oct. 12, 2023

(54) SENSOR NOISE REMOVAL DEVICE AND SENSOR NOISE REMOVAL METHOD

(71) Applicant: Mitsubishi Electric Corporation, Tokyo (JP)

(72) Inventors: Hiroyoshi SHIBATA, Tokyo (JP); Takayuki ITSUI, Tokyo (JP); Mizuho WAKABAYASHI, Tokyo (JP); Shin MIURA, Tokyo (JP)

(73) Assignee: Mitsubishi Electric Corporation, Tokyo (JP)

(21) Appl. No.: 18/043,506

(22) PCT Filed: Nov. 10, 2020
(86) PCT No.: PCT/JP2020/041927

§ 371 Date: Feb. 28, 2023

(51) Int. Cl. G06T 5/00

(52) U.S. Cl. CPC G06T 5/002; G06T 2207/30252; G06T 2207/20081

(57) ABSTRACT

A sensor data acquiring unit that acquires sensor data related to a surrounding situation of a vehicle, a noise determination unit that determines whether or not noise occurs in the sensor data acquired by the sensor data acquiring unit, and a data replacement unit that estimates, for the sensor data in which it is determined by the noise determination unit that the noise occurs, sensor data in which the noise does not occur, thereby generates replacement data corresponding to a noise portion, and replaces the noise portion with the replacement data generated are included.

### TECHNICAL FIELD

The present disclosure relates to a sensor noise removal device and a sensor noise removal method.

### BACKGROUND ART

In processing based on sensor data acquired from a sensor, the acquired sensor data is desirably reliable in order to appropriately perform the processing. For example, if noise occurs in the acquired sensor data, the sensor data is sensor data with low reliability, and there is a possibility that the processing is not appropriately performed.

Conventionally, in a case where the processing based on the sensor data acquired from the sensor is performed, there is known a technique of using sensor data with less noise among the acquired sensor data (See, for example, Patent Literature 1).

### CITATION LIST

### Patent Literatures

Patent Literature 1: JP 2020-91281 A

### SUMMARY OF INVENTION

### Technical Problem

Meanwhile, some processing based on sensor data requires the whole of the acquired sensor data when the processing is performed. For example, in the case of performing processing using an image acquired from a camera, the whole of the acquired image is required. In this case, there is a problem that even if the acquired sensor data has low reliability due to noise, the sensor data has to be used as it is.

Note that, since the conventional technique described above is a technique that does not use sensor data in which noise occurs, the conventional technique cannot solve the above problem.

The present disclosure has been made to solve the problem described above, and an object of the present disclosure is to provide a sensor noise removal device capable of converting sensor data whose reliability is lowered by noise into sensor data in a state where no noise occurs.

### Solution to Problem

A sensor noise removal device according to the present disclosure includes: a sensor data acquiring unit to acquire at least one piece of sensor data related to a surrounding situation of a vehicle; a noise determination unit to determine whether or not noise occurs in the sensor data acquired by the sensor data acquiring unit; and a data replacement unit to estimate, for the sensor data in which it is determined by the noise determination unit that the noise occurs, sensor data in which the noise does not occur, thereby generate replacement data corresponding to a noise portion, and replace the noise portion with the replacement data generated.

### Advantageous Effects of Invention

According to the present disclosure, sensor data whose reliability is lowered by noise can be converted into sensor data in a state where no noise occurs.

### BRIEF DESCRIPTION OF DRAWINGS

FIG. 1 is a diagram illustrating a configuration example of a sensor noise removal device according to a first embodiment.

FIG. 2 is a diagram for describing a concept of an example of replacement performed by a data replacement unit on the basis of first distance data or second distance data in the first embodiment. FIG. 2A is a diagram illustrating an example of a captured image in which it is determined that noise occurs before the data replacement unit performs replacement on the basis of the first distance data or the second distance data, and FIG. 2B is a diagram illustrating an example of an after-replacement captured image after the data replacement unit performs replacement on the basis of the first distance data or the second distance data.

FIG. 3 is a diagram for describing a concept of another example of replacement performed by the data replacement unit on the basis of the first distance data or the second distance data in the first embodiment. FIG. 3A is a diagram illustrating an example of a captured image in which it is determined that noise occurs before the data replacement unit performs replacement on the basis of the first distance data or the second distance data, and FIG. 3B is a diagram illustrating an example of an after-replacement captured image as after-replacement sensor data after the data replacement unit performs replacement on the basis of the first distance data or the second distance data.

FIG. 4 is a flowchart for describing an operation of the sensor noise removal device according to the first embodiment.

FIG. 5 is a flowchart for describing in detail an operation of the data replacement unit in step ST403 in FIG. 4.

FIGS. 6A and 6B are diagrams each illustrating an example of a hardware configuration of the sensor noise removal device according to the first embodiment.

FIG. 7 is a diagram illustrating a configuration example of a sensor noise removal device according to a second embodiment.

FIG. 8 is a flowchart for describing an operation of the sensor noise removal device according to the second embodiment.

FIG. 9 is a diagram illustrating a configuration example of a sensor noise removal device according to a third embodiment.

FIG. 10 is a diagram illustrating a configuration example of a learning device according to the third embodiment.

FIG. 11 is a diagram for describing an example of a neural network.

FIG. 12 is a flowchart for describing an operation of the sensor noise removal device according to the third embodiment.

FIG. 13 is a flowchart for describing an operation of the learning device according to the third embodiment.

### DESCRIPTION OF EMBODIMENTS

Hereinafter, embodiments of the present disclosure will be described in detail with reference to the drawings.

### First Embodiment

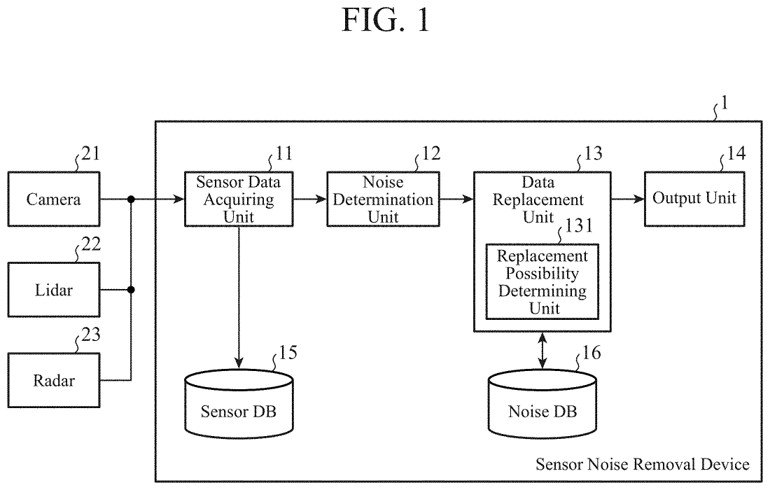

FIG. 1 is a diagram illustrating a configuration example of a sensor noise removal device 1 according to a first embodiment.

In the first embodiment, the sensor noise removal device 1 is assumed to be mounted on a vehicle. In addition, the sensor noise removal device 1 is connected to a plurality of types of sensors mounted on the vehicle, and acquires a plurality of pieces of sensor data related to the surrounding situation of the vehicle acquired by the respective plurality of types of sensors.

The sensor data related to the surrounding situation of the vehicle acquired by the sensors is used for various types of processing related to the vehicle.

Some processing using sensor data cannot substitute sensor data to be used, with other sensor data. In this case, even if noise occurs in the sensor data to be used for the processing and the above other sensor data is normal sensor data in which no noise occurs, the processing is not appropriately performed by using the above other sensor data.

Conventionally, in the case of performing processing using sensor data that cannot be substituted with other sensor data, even if noise occurs in the sensor data to be used, the processing has to use the sensor data in which noise occurs.

For example, in processing of displaying an image acquired by a camera capturing the area behind the vehicle or a camera mounted on a drive recorder on a display mounted on the vehicle, even if noise occurs in the acquired image, the image has to be displayed as it is.

Furthermore, for example, in the case of performing processing using artificial intelligence with certain sensor data as an input, even if noise occurs in the sensor data as an input, the sensor data has to be used as an input as it is.

Therefore, in a case where there is sensor data in which noise occurs among a plurality of pieces of acquired sensor data, the sensor noise removal device 1 according to the first embodiment converts the sensor data in which noise occurs into sensor data in a state where no noise occurs. Specifically, the sensor noise removal device 1 estimates sensor data in which no noise occurs, thereby generates data (hereinafter, referred to as “replacement data”) corresponding to a portion in which noise occurs (hereinafter, referred to as “noise portion”), and replaces the noise portion of the sensor data in which noise occurs with the generated replacement data. In the following first embodiment, converting the noise portion in the sensor data in which noise occurs into the sensor data in a state where no noise occurs is also simply referred to as “replacement”.

In the first embodiment, sensor data in which the sensor noise removal device 1 has performed replacement in such a manner that no noise occurs is referred to as “after-replacement sensor data”. Note that the sensor noise removal device 1 replaces the noise portion with the replacement data in the replacement, but the characteristics of the data before the replacement are not changed by the replacement.

The sensor noise removal device 1 is only required to replace at least sensor data that cannot be substituted with other sensor data when processing using the sensor data is performed, in a case where noise occurs in the sensor data.

In the first embodiment, as illustrated in FIG. 1, the plurality of sensors are assumed to be a camera 21, a lidar 22, and a radar 23. Note that, in the first embodiment, the number of sensors connected to the sensor noise removal device 1 is three, but this is merely an example. The number of sensors connected to the sensor noise removal device 1 may be two, four or more, or one.

The camera 21 captures the area around the vehicle. The camera 21 outputs an image obtained by capturing the area around the vehicle (hereinafter, referred to as “captured image”) to the sensor noise removal device 1.

The lidar 22 outputs point cloud data obtained by irradiating the area around the vehicle with laser light to the sensor noise removal device 1 as distance data (hereinafter, referred to as “first distance data”). The point cloud data indicates a distance vector and a reflection intensity at each point where the laser light is reflected.

The radar 23 scans the area around the vehicle with a millimeter wave and transmits the millimeter wave, and outputs distance data obtained on the basis of the received radio wave (hereinafter, referred to as “second distance data”) to the sensor noise removal device 1. The second distance data indicates a distance vector at each point where the millimeter wave is reflected.

It is assumed that areas from which the camera 21, the lidar 22, and the radar 23 detect the surrounding situation of the vehicle overlap with each other. For example, the camera 21 captures the area behind the vehicle. The lidar 22 and the radar 23 detect an object present behind the vehicle.

In the first embodiment, it is assumed that the captured image acquired from the camera 21 cannot be substituted with the first distance data acquired from the lidar 22 or the second distance data acquired from the radar 23 when processing using the captured image is performed. In addition, it is assumed that an event causing noise may occur in the camera 21.

In a case where an event causing noise occurs in the camera 21, noise occurs in the captured image. The event causing noise is, for example, an event in which a water droplet, dirt, or an insect adheres to the lens of the camera 21. In this case, blurring occurs as noise in the captured image. In a case where noise occurs in the captured image, the sensor noise removal device 1 estimates a captured image in which the noise does not occur, thereby generates replacement data corresponding to pixels in the noise portion, and replaces the noise portion of the captured image including the noise with the generated replacement data.

Note that, in the first embodiment, it is assumed that no event causing noise occurs in the lidar 22 and the radar 23. That is, it is assumed that no noise occurs in the first distance data and the second distance data.

Details of the replacement by the sensor noise removal device 1 will be described later.

As illustrated in FIG. 1, the sensor noise removal device 1 according to the first embodiment includes a sensor data acquiring unit 11, a noise determination unit 12, a data replacement unit 13, an output unit 14, a sensor database (DB) 15, and a noise DB 16. The data replacement unit 13 includes a replacement possibility determining unit 131.

The sensor data acquiring unit 11 acquires sensor data related to the surrounding situation of the vehicle. Specifically, the sensor data acquiring unit 11 acquires the captured image captured by the camera 21, the first distance data acquired by the lidar 22, and the second distance data acquired by the radar 23.

The sensor data acquiring unit 11 outputs the acquired captured image, the first distance data, and the second distance data to the noise determination unit 12.

The sensor data acquiring unit 11 also stores the acquired captured image, the first distance data, and the second distance data in the sensor DB 15. At that time, the sensor data acquiring unit 11 stores, for example, the captured image, the first distance data, and the second distance data in the sensor DB 15 in association with information related to a data acquisition date and time.

The noise determination unit 12 determines whether or not noise occurs in the sensor data acquired by the sensor data acquiring unit 11.

Specifically, in the first embodiment, the noise determination unit 12 determines whether or not noise occurs in the captured image acquired by the sensor data acquiring unit 11.

For example, the noise determination unit 12 determines whether or not blurring occurs in the captured image using known image recognition processing. In a case where blurring occurs in the captured image, the noise determination unit 12 determines that noise occurs in the captured image. Note that, for example, if blurring occurs even in one pixel in the captured image, the noise determination unit 12 determines that noise occurs in the captured image. In a case where no blurring occurs in the captured image, the noise determination unit 12 determines that no noise occurs in the captured image.

The noise determination unit 12 outputs the captured image acquired from the sensor data acquiring unit 11 to the data replacement unit 13 together with a determination result as to whether or not noise is included. At that time, the noise determination unit 12 also outputs the first distance data and the second distance data acquired from the sensor data acquiring unit 11 to the data replacement unit 13.

The data replacement unit 13 estimates, for the sensor data in which it is determined by the noise determination unit 12 that noise occurs, sensor data in which no noise occurs, thereby generates replacement data corresponding to a noise portion of the sensor data, and replaces the noise portion with the generated replacement data. In the first embodiment, the data replacement unit 13 estimates, for the captured image in which it is determined by the noise determination unit 12 that noise occurs, a captured image in which no noise occurs, thereby generates replacement data corresponding to the noise portion, and replaces the noise portion with the generated replacement data.

Specifically, first, the replacement possibility determining unit 131 in the data replacement unit 13 determines whether or not it is possible to perform replacement on the captured image in which it is determined that noise occurs, by determining whether or not a condition that enables replacement of the noise portion in the sensor data in which it is determined by the noise determination unit 12 that noise occurs (hereinafter, referred to as “replaceable condition”) is satisfied.

In a case where the replacement possibility determining unit 131 determines that replacement can be performed, the data replacement unit 13 generates replacement data, and replaces the noise portion of the captured image in which it is determined by the noise determination unit 12 that noise occurs with the generated replacement data.

Here, the replaceable condition includes a first replaceable condition and a second replaceable condition.

As the first replaceable condition, a condition that enables the noise portion in sensor data in which it is determined by the noise determination unit 12 that noise occurs to be replaced using only the sensor data is set.

For example, the first replaceable condition is that, in a case where the sensor data in which noise occurs is a captured image, the number of pixels in which noise occurs is equal to or less than a preset threshold (hereinafter, referred to as “replacement possibility determining threshold”).

As the second replaceable condition, a condition that enables the noise portion in sensor data in which it is determined by the noise determination unit 12 that noise occurs to be replaced using sensor data in which it is determined by the noise determination unit 12 that no noise occurs among a plurality of pieces of sensor data acquired by the sensor data acquiring unit 11 is set.

For example, the second replaceable condition is that there is other sensor data in which no noise occurs, and which is acquired for the real space corresponding to the area in which noise occurs in the sensor data in which noise occurs.

The replacement possibility determining unit 131 first determines whether or not the first replaceable condition is satisfied.

For example, in a case where the contents of the first replaceable condition are as in the example described above, the replacement possibility determining unit 131 first determines whether or not the number of pixels in which noise occurs is equal to or less than the replacement possibility determining threshold in the captured image in which it is determined by the noise determination unit 12 that noise occurs.

In a case where the number of pixels in which noise occurs is equal to or less than the replacement possibility determining threshold, the replacement possibility determining unit 131 determines that the first replaceable condition is satisfied and that it is possible to replace the noise portion in the captured image in which it is determined by the noise determination unit 12 that noise occurs using only the captured image.

The replacement possibility determining unit 131 outputs, to the data replacement unit 13, information indicating that replacement can be performed using only the captured image in which it is determined by the noise determination unit 12 that noise occurs.

In a case where the number of pixels in which noise occurs is larger than the replacement possibility determining threshold, the replacement possibility determining unit 131 determines that the first replaceable condition is not satisfied and that it is impossible to replace the noise portion in the captured image in which it is determined by the noise determination unit 12 that noise occurs using only the captured image. This is because, in a case where a portion where noise occurs is large, it is difficult to estimate what captured image will be obtained if no noise occurs in the noise portion.

When determining that the first replaceable condition is not satisfied, the replacement possibility determining unit 131 determines whether or not the second replaceable condition is satisfied.

For example, in a case where the contents of the second replaceable condition are as in the example described above, the replacement possibility determining unit 131 determines whether or not there is the first distance data or the second distance data acquired for the real space corresponding to the area in which noise occurs in the captured image.

Note that, as described above, the areas from which the camera 21, the lidar 22, and the radar 23 detect the surrounding situation of the vehicle overlap with each other. In addition, it is assumed that installation positions of the camera 21, the lidar 22, and the radar 23 and the areas from which the camera 21, the lidar 22, and the radar 23 can detect the surrounding situation of the vehicle are known in advance. As a result, the replacement possibility determining unit 131 can identify the first distance data or the second distance data corresponding to the area in which noise occurs in the captured image.

In a case where there is the first distance data or the second distance data corresponding to the area in which noise occurs in the captured image, the replacement possibility determining unit 131 determines that the second replaceable condition is satisfied and that replacement can be performed on the basis of the sensor data in which it is determined by the noise determination unit 12 that no noise occurs among the plurality of pieces of sensor data acquired by the sensor data acquiring unit 11, in other words, the first distance data or the second distance data.

The replacement possibility determining unit 131 outputs, to the data replacement unit 13, information indicating that replacement can be performed on the basis of the sensor data in which it is determined by the noise determination unit 12 that no noise occurs among the plurality of pieces of sensor data acquired by the sensor data acquiring unit 11, in other words, the first distance data or the second distance data.

When determining that neither the first replaceable condition nor the second replaceable condition is satisfied, the replacement possibility determining unit 131 determines that it is impossible to replace the captured image in which it is determined by the noise determination unit 12 that noise occurs. The replacement possibility determining unit 131 outputs information indicating that replacement is impossible to the data replacement unit 13.

In a case where the information indicating that replacement can be performed using only the captured image in which it is determined by the noise determination unit 12 that noise occurs is output from the replacement possibility determining unit 131, the data replacement unit 13 estimates a captured image in which no noise occurs on the basis of the captured image in which it is determined that noise occurs, and thereby generates replacement data. Then, the data replacement unit 13 replaces the noise portion of the captured image with the generated replacement data.

Specifically, for example, the data replacement unit 13 generates replacement data from a pixel which is adjacent to a pixel included in the noise portion and in which no noise occurs (hereinafter, referred to as “neighboring pixel”), and replaces the pixel in the noise portion with the generated replacement data.

More specifically, for example, the data replacement unit 13 estimates that the noise portion will have a pixel value close to that of the neighboring pixel in a captured image in which no noise occurs, and generates replacement data having an average value of pixel values of the neighboring pixels as a pixel value. Note that the range of pixels to be set as the neighboring pixels is determined in advance. Furthermore, for example, the data replacement unit 13 may calculate a difference between the average value of the pixel values of the noise portion and each of the neighboring pixels, extract neighboring pixels whose difference is less than a preset threshold, and generate replacement data having the average value of the pixel values of the extracted neighboring pixels as a pixel value. As a result, the data replacement unit 13 can generate the replacement data on the basis of the neighboring pixels estimated to be more relevant to the pixel value of the noise portion. Furthermore, for example, the data replacement unit 13 may estimate that the same pixel value as the pixel value of a pixel adjacent to the noise portion will continue in the captured image in which no noise occurs, and generate replacement data having the same pixel value as the adjacent pixel value. Moreover, for example, in a case where the noise portion has a narrow area such as one pixel, the data replacement unit 13 may generate replacement data from which noise has been removed by applying a known super-resolution technology to the pixel in the noise portion.

In this manner, the data replacement unit 13 generates the replacement data on the basis of the neighboring pixels or the pixels in the noise portion and replaces the pixels in the noise portion with the replacement data, thereby generating a captured image (hereinafter, referred to as “after-replacement captured image”) as after-replacement sensor data in which the noise portion is converted into an image estimated to have been captured in a state where no noise occurs.

On the other hand, in case where the information indicating that replacement can be performed on the basis of the first distance data or the second distance data in which it is determined by the noise determination unit 12 that no noise occurs is output from the replacement possibility determining unit 131, the data replacement unit 13 estimates a captured image in which no noise occurs on the basis of the first distance data or the second distance data among the plurality of pieces of sensor data acquired by the sensor data acquiring unit 11, and thereby generates replacement data. The data replacement unit 13 then replaces the noise portion of the captured image in which it is determined by the noise determination unit 12 that noise occurs with the generated replacement data.

A concept of replacement performed by the data replacement unit 13 on the basis of the first distance data or the second distance data will be described.

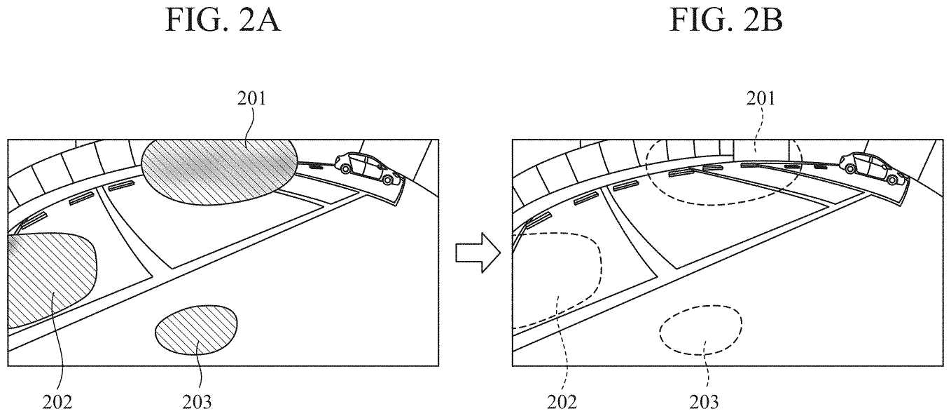

FIG. 2 is a diagram for describing a concept of an example of the replacement performed by the data replacement unit 13 on the basis of the first distance data or the second distance data in the first embodiment.

FIG. 2A is a diagram illustrating an example of a captured image in which it is determined that noise occurs before the data replacement unit 13 performs replacement on the basis of the first distance data or the second distance data, and FIG. 2B is a diagram illustrating an example of an after-replacement captured image after the data replacement unit 13 performs replacement on the basis of the first distance data or the second distance data.

In the captured image illustrated in FIG. 2A, areas indicated by 201 to 203 are areas in which blurring occurs due to noise.

First, on the basis of the first distance data or the second distance data, the data replacement unit 13 estimates whether or not an object is detected in a noise portion of the captured image, in other words, in each of the areas 201 to 203 in FIG. 2A. For example, in a case where an object present in the real space corresponding to the noise portion of the captured image is detected in the first distance data or the second distance data, the data replacement unit 13 estimates that the object is also detected in the captured image. In a case where an object present in the real space corresponding to the noise portion of the captured image is not detected in the first distance data or the second distance data, the data replacement unit 13 estimates that no object is detected also in the captured image.

As an example, it is assumed that no object is detected in the first distance data and the second distance data. Then, the data replacement unit 13 estimates that no object is detected in the noise portion of the captured image.

In this case, for example, the data replacement unit 13 generates replacement data from a neighboring pixel which is adjacent to a pixel included in the noise portion and in which no noise occurs, and replaces the pixel in the noise portion with the generated replacement data. The details of generating the replacement data from the neighboring pixel in which no noise occurs and replacing the pixel in the noise portion with the generated replacement data have been already described, and thus redundant description will be omitted.

As a result, for example, as illustrated in FIG. 2B, the data replacement unit 13 generates an after-replacement captured image in which the areas 201 to 203 in FIG. 2A in which noise occurs are converted into images without blurring. In FIG. 2B, pixels in the portions 201 to 203 in FIG. 2A are replaced with pixels in which blurring does not occur and which are estimated to correspond to a captured image in a case where there is no object.

Note that, in FIG. 2B, for convenience, the outer frame of each of the noise portions 201 to 203 in FIG. 2A is indicated by a dotted line.

In the above example, the data replacement unit 13 estimates that no object is detected in the noise portion of the captured image, but this is merely an example.

A concept of an example of replacement by the data replacement unit 13 in a case where the data replacement unit 13 estimates that an object is detected in the noise portion of the captured image will be described.

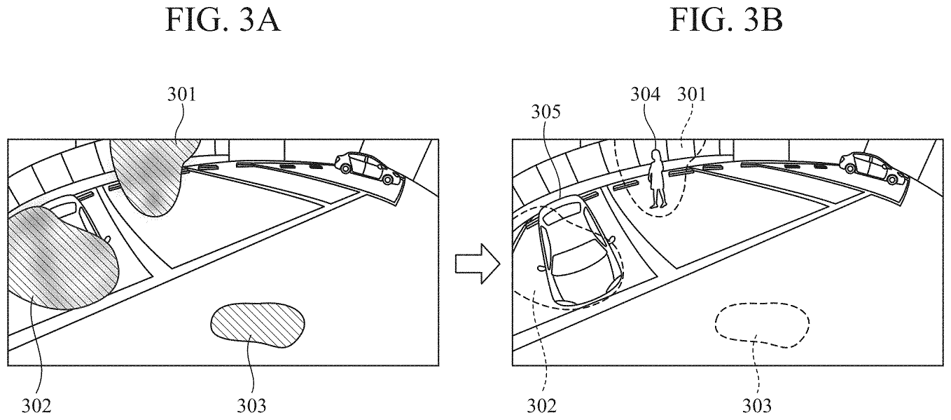

FIG. 3 is a diagram for describing a concept of another example of replacement performed by the data replacement unit 13 on the basis of the first distance data or the second distance data in the first embodiment.

FIG. 3A is a diagram illustrating an example of a captured image in which it is determined that noise occurs before the data replacement unit 13 performs replacement on the basis of the first distance data or the second distance data, and FIG. 3B is a diagram illustrating an example of an after-replacement captured image as after-replacement sensor data after the data replacement unit 13 performs replacement on the basis of the first distance data or the second distance data.

For example, in a case where an object present in the real space corresponding to the noise portion of the captured image is detected in the first distance data or the second distance data, the data replacement unit 13 estimates that the object is also detected in the captured image. In this case, the data replacement unit 13 generates replacement data in such a manner that the object estimated to have been detected appears.

Here, for example, it is assumed that, in the first distance data or the second distance data, a person is detected in the real space corresponding to a noise portion 301 in FIG. 3A. In addition, for example, it is assumed that, in the first distance data or the second distance data, a car is detected in the real space corresponding to a noise portion 302 in FIG. 3A. In this case, the data replacement unit 13 estimates that a person is detected in the noise portion 301 in FIG. 3A and a car is detected in the noise portion 302 in FIG. 3A in the captured image, and thus generates replacement data in such a manner that a person appears in the noise portion 301 in FIG. 3A and a car appears in the noise portion 302 in FIG. 3A.

At that time, the data replacement unit 13 does not need to generate replacement data so as to strictly reproduce the object detected in the first distance data or the second distance data. The data replacement unit 13 is only required to generate replacement data as data that indicates the position of the detected object, the type of the object, or the orientation of the object. For example, the data replacement unit 13 does not need to generate replacement data as data that indicates the color of the detected object.

As a result, for example, as illustrated in FIG. 3B, the data replacement unit 13 generates an after-replacement captured image in which the areas 301 to 203 in FIG. 3A in which noise occurs are converted into images without blurring.

In FIG. 3B, blurring does not occur in the noise portion 301 in FIG. 3A, and a person is rendered (see 304 in FIG. 3B). Furthermore, in FIG. 3B, blurring does not occur in the noise portion 302 in FIG. 3A, and a car is rendered (see 305 in FIG. 3B).

Note that the data replacement unit 13 estimates that an object is not detected in the noise portion 303 in FIG. 3A, and thus the noise portion is replaced with pixels in which blurring does not occur and which are estimated to correspond to a captured image in a case where there is no object.

Note that, in FIG. 3B, for convenience, the outer frame of each of the noise portions 301 to 303 in FIG. 3A is indicated by a dotted line.

As described with reference to FIGS. 2 and 3, the data replacement unit 13 generates the replacement data on the basis of the first distance data or the second distance data and replaces pixels in the noise portion with the replacement data, thereby generating an after-replacement captured image in which the noise portion is converted into an image estimated to have been captured in a state where no noise occurs.

Furthermore, in a case where the information indicating that replacement is impossible is output from the replacement possibility determining unit 131, the data replacement unit 13 stores, in the noise DB 16, information in which the captured image determined to have noise, the information indicating that replacement of the captured image is impossible, and information enabling identification of the noise portion in which noise occurs in the captured image are associated with each other as replacement impossible information.

By storing the replacement impossible information, the replacement possibility determining unit 131 can determine whether or not replacement can be performed on a captured image by referring to the replacement impossible information next time.

When performing replacement on the captured image, the data replacement unit 13 outputs the after-replacement captured image to the output unit 14. In a case where no replacement is performed on the captured image, the data replacement unit 13 outputs the captured image acquired by the sensor data acquiring unit 11 to the output unit 14. In addition, the data replacement unit 13 outputs the first distance data and the second distance data acquired by the sensor data acquiring unit 11 to the output unit 14.

The output unit 14 outputs the sensor data output from the data replacement unit 13. Specifically, the output unit 14 outputs the after-replacement captured image or the captured image, the first distance data, and the second distance data output from the data replacement unit 13.

The output destination of each piece of sensor data is a device that performs processing using the sensor data. For example, in a case where a display (not illustrated) mounted on the vehicle displays a captured image, the output unit 14 outputs the after-replacement captured image or the captured image to the display.

The sensor DB 15 stores the sensor data acquired by the sensor data acquiring unit 11.

Note that, here, as illustrated in FIG. 1, the sensor DB 15 is provided in the sensor noise removal device 1, but this is merely an example. The sensor DB 15 may be provided at a place that is outside the sensor noise removal device 1 and that can be referred to by the sensor noise removal device 1.

The noise DB 16 stores the replacement impossible information.

The noise DB 16 may store, as initial data, a captured image generated when a travel simulation is performed for each vehicle type, or a captured image acquired from the camera 21 during test travel.

In a case where the initial data described above is stored in the noise DB 16, the data replacement unit 13 may generate replacement data on the basis of the captured image stored in the noise DB 16 when performing replacement. For example, in a case where the data replacement unit 13 estimates that no object is detected in the noise portion of the captured image in which it is determined by the noise determination unit 12 that noise occurs, the data replacement unit 13 extracts initial data portion corresponding to the noise portion, and generates the initial data portion as the replacement data. Furthermore, for example, in a case where the data replacement unit 13 estimates that an object is detected in the noise portion of the captured image in which it is determined by the noise determination unit 12 that noise occurs, the data replacement unit 13 extracts the initial data portion corresponding to the noise portion, superimposes the object estimated to have been detected on the initial data portion, and thereby generates the replacement data.

Note that, here, as illustrated in FIG. 1, the noise DB 16 is provided in the sensor noise removal device 1, but this is merely an example. The noise DB 16 may be provided at a place that is outside the sensor noise removal device 1 and that can be referred to by the sensor noise removal device 1.

An operation of the sensor noise removal device 1 according to the first embodiment will be described.

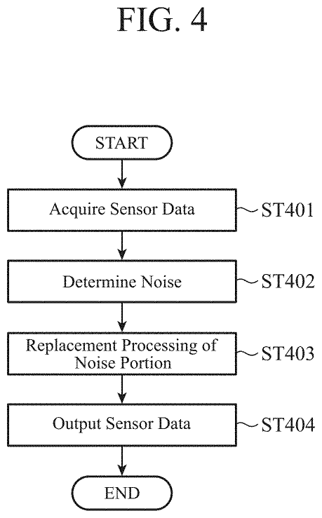

FIG. 4 is a flowchart for describing the operation of the sensor noise removal device 1 according to the first embodiment.

The sensor data acquiring unit 11 acquires sensor data related to the surrounding situation of the vehicle (step ST401). Specifically, the sensor data acquiring unit 11 acquires the captured image captured by the camera 21, the first distance data acquired by the lidar 22, and the second distance data acquired by the radar 23.

The sensor data acquiring unit 11 outputs the acquired captured image, the first distance data, and the second distance data to the noise determination unit 12.

The sensor data acquiring unit 11 also stores the acquired captured image, the first distance data, and the second distance data in the sensor DB 15.

The noise determination unit 12 determines whether or not noise occurs in the sensor data acquired by the sensor data acquiring unit 11 in step ST401 (step ST402).

Specifically, the noise determination unit 12 determines whether or not noise occurs in the captured image acquired by the sensor data acquiring unit 11.

The noise determination unit 12 outputs the captured image acquired from the sensor data acquiring unit 11 to the data replacement unit 13 together with a determination result as to whether or not noise is included. At that time, the noise determination unit 12 also outputs the first distance data and the second distance data acquired from the sensor data acquiring unit 11 to the data replacement unit 13.

The data replacement unit 13 estimates, for the sensor data in which it is determined in step ST402 by the noise determination unit 12 that noise occurs, sensor data in which no noise occurs, thereby generates replacement data corresponding to a noise portion of the sensor data, and replaces the noise portion with the generated replacement data (step ST403). Specifically, the data replacement unit 13 estimates, for the captured image in which it is determined by the noise determination unit 12 that noise occurs, a captured image in which no noise occurs, thereby generates replacement data corresponding to the noise portion, and replaces the noise portion with the generated replacement data.

When performing replacement on the captured image, the data replacement unit 13 outputs the after-replacement captured image to the output unit 14. In a case where no replacement is performed on the captured image, the data replacement unit 13 outputs the captured image acquired by the sensor data acquiring unit 11 to the output unit 14. In addition, the data replacement unit 13 outputs the first distance data and the second distance data acquired by the sensor data acquiring unit 11 to the output unit 14.

The output unit 14 outputs the sensor data output from the data replacement unit 13 in step ST403 (step ST404). Specifically, the output unit 14 outputs the after-replacement captured image or the captured image, the first distance data, and the second distance data output from the data replacement unit 13.

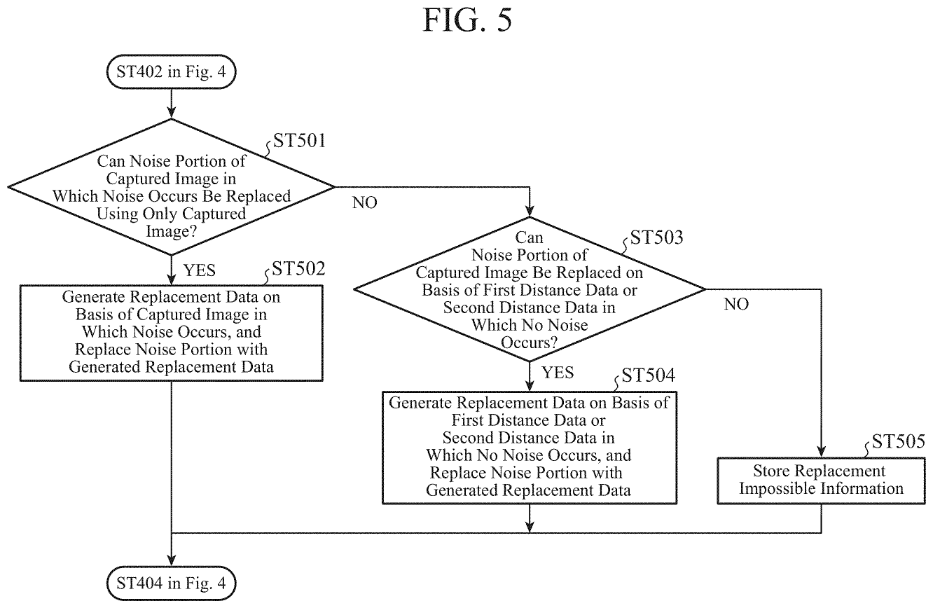

FIG. 5 is a flowchart for describing in detail an operation of the data replacement unit 13 in step ST403 in FIG. 4.

By determining whether or not the first replaceable condition is satisfied in the captured image in which it is determined in step ST402 in FIG. 4 by the noise determination unit 12 that noise occurs, the replacement possibility determining unit 131 determines whether or not the noise portion in the captured image in which it is determined that noise occurs can be replaced using only the captured image (step ST501).

In step ST501, if the replacement possibility determining unit 131 determines that the first replaceable condition is satisfied, that is, determines that the noise portion in the captured image in which it is determined that noise occurs can be replaced using only the captured image (if “YES” in step ST501), the replacement possibility determining unit 131 outputs, to the data replacement unit 13, information indicating that replacement can be performed using only the captured image in which it is determined by the noise determination unit 12 that noise occurs.

The data replacement unit 13 estimates a captured image in which no noise occurs on the basis of the captured image in which it is determined that noise occurs, and thereby generates replacement data. Then, the data replacement unit 13 replaces the noise portion of the captured image with the generated replacement data (step ST502).

On the other hand, in step ST501, if the replacement possibility determining unit 131 determines that the first replaceable condition is not satisfied, that is, determines that the noise portion in the captured image in which it is determined that noise occurs cannot be replaced using only the captured image (if “NO” in step ST501), the replacement possibility determining unit 131 performs an operation in step ST503.

In step ST503, the replacement possibility determining unit 131 determines whether or not it is possible to perform replacement on the noise portion of the captured image on the basis of the first distance data or the second distance data among the plurality of pieces of sensor data acquired by the sensor data acquiring unit 11 in step ST401 in FIG. 4, by determining whether or not the second replaceable condition is satisfied (step ST503).

In step ST503, if the replacement possibility determining unit 131 determines that the second replaceable condition is satisfied, that is, determines that the noise portion of the captured image can be replaced on the basis of the first distance data or the second distance data (if “YES” in step ST503), the replacement possibility determining unit 131 outputs, to the data replacement unit 13, information indicating that replacement can be performed on the basis of the first distance data or the second distance data.

The data replacement unit 13 estimates a captured image in which no noise occurs on the basis of the first distance data or the second distance data in which it is determined by the noise determination unit 12 that no noise occur among the plurality of pieces of sensor data acquired by the sensor data acquiring unit 11 in step ST401 in FIG. 4, and thereby generates replacement data. The data replacement unit 13 then replaces the noise portion of the captured image in which it is determined by the noise determination unit 12 that noise occurs with the generated replacement data (step ST504).

In step ST503, if the replacement possibility determining unit 131 determines that the second replaceable condition is not satisfied, that is, determines that the noise portion of the captured image cannot be replaced on the basis of the first distance data or the second distance data (if “NO” in step ST503), the replacement possibility determining unit 131 outputs, to the data replacement unit 13, information indicating that replacement is impossible.

The data replacement unit 13 stores the replacement impossible information in the noise DB 16 (step ST505).

As described above, when determining that noise occurs in the sensor data (captured image) related to the surrounding situation of the vehicle, the sensor noise removal device 1 according to the first embodiment estimates, for the sensor data in which it is determined that noise occurs, sensor data in which no noise occurs, thereby generates replacement data corresponding to the noise portion, and replaces the noise portion with the generated replacement data. As a result, the sensor noise removal device 1 can convert the sensor data whose reliability is lowered by noise into the sensor data in a state where no noise occurs.

In the first embodiment described above, the data replacement unit 13 has a function of generating replacement data on the basis of the captured image in which it is determined that noise occurs and replacing the noise portion of the captured image with the generated replacement data (hereinafter, referred to as “first replacement function”), and a function of generating replacement data on the basis of the first distance data or the second distance data in which it is determined that no noise occurs and replacing the noise portion of the captured image with the replacement data (hereinafter, referred to as “second replacement function”). However, this is merely an example. The data replacement unit 13 may have either the first replacement function or the second replacement function.

In a case where the data replacement unit 13 has only the first replacement function, the replacement possibility determining unit 131 only determines whether the first replaceable condition is satisfied.

In this case, the operations in steps ST503 to ST504 are omitted in the operation of the sensor noise removal device 1 described with reference to FIG. 5.

In addition, in a case where the data replacement unit 13 has only the second replacement function, the replacement possibility determining unit 131 only determines whether the second replaceable condition is satisfied.

In this case, the operations in steps ST501 to ST502 are omitted in the operation of the sensor noise removal device 1 described with reference to FIG. 5.

Furthermore, in the first embodiment described above, the data replacement unit 13 includes the replacement possibility determining unit 131, but the replacement possibility determining unit 131 is not essential. For example, the data replacement unit 13 may have the function of the replacement possibility determining unit 131, and the data replacement unit 13 may determine whether or not the replaceable condition is satisfied when performing replacement.

Furthermore, it is assumed in the first embodiment described above that noise may occur in the captured image, but this is merely an example. In the first embodiment, it may be assumed that noise may occur in the first distance data and the second distance data.

The noise determination unit 12 can determine whether or not noise occurs, for each piece of the sensor data acquired by the sensor data acquiring unit 11.

For example, the noise determination unit 12 can determine whether or not noise occurs in the first distance data or the second distance data. Specifically, for example, in a case where any one of the first distance data, more specifically, the point cloud data included in the first distance data indicates “0”, the noise determination unit 12 determines that noise occurs in the first distance data. Furthermore, in a case where the second distance data indicates “0”, the noise determination unit 12 determines that noise occurs in the second distance data.

As the first replaceable condition in a case where the sensor data is anything other than an image, for example, in a case where the sensor data is the first distance data, a condition that the number of pieces of data indicating “0” in the point cloud data obtained by irradiating the area around the vehicle with laser light is equal to or less than a preset threshold is set. In this case, for example, it is assumed that the first replaceable condition is satisfied and the replacement possibility determining unit 131 outputs information indicating that replacement can be performed using only the first distance data in which it is determined by the noise determination unit 12 that noise occurs. The data replacement unit 13 then generates, for data included in the noise portion in the point cloud data, replacement data from data in which no noise occurs, and replaces the data in the noise portion with the generated replacement data.

Furthermore, in the first embodiment described above, the noise determination unit 12 may determine whether or not noise occurs in the sensor data on the basis of the characteristics of the sensor data.

The sensor data may have a characteristic of being affected by the environment or the like. When affected by the environment or the like, the sensor data may not indicate a normal value.

For example, in a case where the sensor data is a captured image, the captured image has a characteristic of being affected by a high beam of an oncoming vehicle, light of a street lamp, or the like. When there is a high beam of an oncoming vehicle, light of a street lamp, or the like, so-called blown-out highlights occur in a portion receiving the high beam, the light of the street lamp, or the like in the captured image. In a case where there are pixels whose brightness is equal to or greater than a preset threshold in the captured image, the noise determination unit 12 determines that the captured image is affected by a high beam, light from a street lamp, or the like, and determines that a portion in which the blown-out highlights occur is a noise portion affected by a high beam or the like.

Furthermore, for example, the captured image has a characteristic of being affected by weather or a time period. For example, in the case of bad weather such as fog or at night, the captured image may be an unclear captured image. In a case where there are pixels whose definition is equal to or less than a preset threshold in the captured image, the noise determination unit 12 determines that the captured image is affected by weather or a time period, and determines that a portion of the pixels whose definition is equal to or less than the threshold is the noise portion. The noise determination unit 12 may acquire the information related to the weather from, for example, a weather DB (not illustrated) in which the information related to the weather is stored or a website. Furthermore, the noise determination unit 12 may acquire the information related to a time period from, for example, a clock (not illustrated) mounted on the vehicle.

Moreover, for example, the first distance data and the second distance data have a characteristic of being affected by water. In a case where the sensor data is the first distance data or the second distance data, for example, when there is a waterfall around the vehicle, the laser light emitted from the lidar 22 or the millimeter wave emitted from the radar 23 passes through the waterfall, and thus the first distance data and the second distance data are not correctly acquired. For example, when there is a waterfall around the vehicle, the noise determination unit 12 determines that the first distance data and the second distance data are affected by the waterfall, and determines that noise occurs in the first distance data and the second distance data. Note that the noise determination unit 12 may acquire the information indicating that there is a waterfall around the vehicle from, for example, a map information DB (not illustrated).

For each piece of sensor data, information related to what kind of environment or the like affects the sensor data (hereinafter, referred to as “characteristic definition information”) is set in advance and stored in a place that can be referred to by the noise determination unit 12. The noise determination unit 12 determines an environment or the like to be considered for the sensor data, by referring to the characteristic definition information. The noise determination unit 12 then determines whether or not noise occurs in the sensor data in consideration of the environment or the like.

As described above, the sensor noise removal device 1 can also determine whether or not noise occurs in the sensor data on the basis of the characteristics of the sensor data acquired by the sensor data acquiring unit 11. As a result, the sensor noise removal device 1 can determine whether or not noise occurs in the sensor data in consideration of the characteristics of the sensor data.

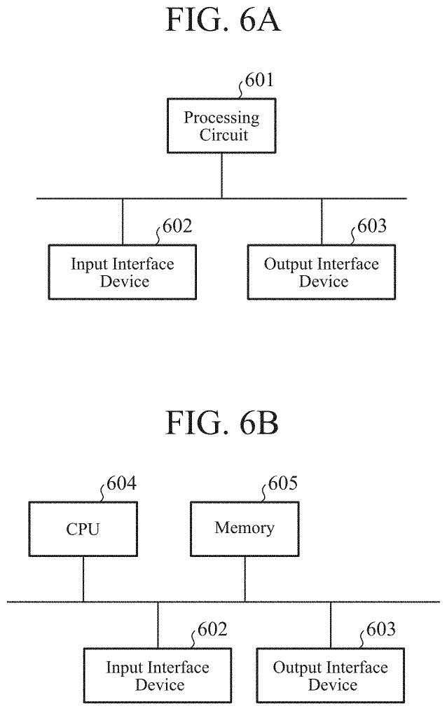

FIGS. 6A and 6B are diagrams each illustrating an example of a hardware configuration of the sensor noise removal device 1 according to the first embodiment.

In the first embodiment, the functions of the sensor data acquiring unit 11, the noise determination unit 12, the data replacement unit 13, and the output unit 14 are implemented by a processing circuit 601. That is, the sensor noise removal device 1 includes the processing circuit 601 that, in a case where noise occurs in the acquired sensor data, executes control to estimate sensor data in which no noise occurs for the sensor data in which the noise occurs, thereby generate replacement data corresponding to the noise portion, and replace the noise portion with the generated replacement data.

The processing circuit 601 may be dedicated hardware as illustrated in FIG. 6A, or may be a central processing unit (CPU) 604 that executes a program stored in a memory 605 as illustrated in FIG. 6B.

In a case where the processing circuit 601 is dedicated hardware, the processing circuit 601 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit 601 is the CPU 604, the functions of the sensor data acquiring unit 11, the noise determination unit 12, the data replacement unit 13, and the output unit 14 are implemented by software, firmware, or a combination of software and firmware. The software or firmware is described as a program and stored in the memory 605. By reading and executing the program stored in the memory 605, the processing circuit 601 performs the functions of the sensor data acquiring unit 11, the noise determination unit 12, the data replacement unit 13, and the output unit 14. That is, the sensor noise removal device 1 includes the memory 605 for storing a program that results in steps ST401 to ST404 in FIG. 4 being performed when executed by the processing circuit 601. It can also be said that the program stored in the memory 605 causes a computer to perform the procedures or methods implemented by the sensor data acquiring unit 11, the noise determination unit 12, the data replacement unit 13, and the output unit 14. Here, the memory 605 corresponds to, for example, a nonvolatile or volatile semiconductor memory such as a RAM, a read only memory (ROM), a flash memory, an erasable programmable read only memory (EPROM), or an electrically erasable programmable read only memory (EEPROM), a magnetic disk, a flexible disk, an optical disk, a compact disk, a mini disk, a digital versatile disc (DVD), or the like.

Note that a part of the functions of the sensor data acquiring unit 11, the noise determination unit 12, the data replacement unit 13, and the output unit 14 may be implemented by dedicated hardware, whereas another part thereof may be implemented by software or firmware. For example, the functions of the sensor data acquiring unit 11 and the output unit 14 can be implemented by the processing circuit 601 as dedicated hardware, and the functions of the noise determination unit 12 and the data replacement unit 13 can be implemented by the processing circuit 601 reading and executing a program stored in the memory 605.

Furthermore, the sensor DB 15 and the noise DB 16 use the memory 605. Note that this is an example, and the sensor DB 15 and the noise DB 16 may be configured by an HDD, a solid state drive (SSD), a DVD, or the like.

Furthermore, the sensor noise removal device 1 includes an input interface device 602 and an output interface device 603 that perform wired communication or wireless communication with a device such as the camera 21, the lidar 22, or the radar 23.

As described above, according to the first embodiment, the sensor noise removal device 1 is configured to include: the sensor data acquiring unit 11 that acquires sensor data related to the surrounding situation of the vehicle; the noise determination unit 12 that determines whether or not noise occurs in the sensor data acquired by the sensor data acquiring unit 11; and the data replacement unit 13 that estimates, for the sensor data in which it is determined by the noise determination unit 12 that noise occurs, sensor data in which no noise occurs, thereby generates replacement data corresponding to the noise portion, and replaces the noise portion with the generated replacement data. As a result, the sensor noise removal device 1 can convert the sensor data whose reliability is lowered by noise into the sensor data in a state where no noise occurs.

In addition, the sensor noise removal device 1 includes the replacement possibility determining unit 131 that determines whether or not the noise portion can be replaced in the sensor data in which it is determined by the noise determination unit 12 that noise occurs. In a case where the replacement possibility determining unit 131 determines that the replacement is possible, the data replacement unit 13 replaces the noise portion of the sensor data in which it is determined by the noise determination unit 12 that noise occurs with the replacement data. When determining that the replacement is impossible, next time the replacement possibility determining unit 131 can determine, by referring to the replacement impossible information indicating that the replacement is impossible, whether or not sensor data determined to have noise can be replaced.

Further, in the sensor noise removal device 1, the sensor data acquiring unit 11 acquires a plurality of pieces of sensor data. The data replacement unit 13 estimates sensor data in which no noise occurs on the basis of sensor data in which it is determined by the noise determination unit 12 that no noise occurs among the plurality of pieces of sensor data acquired by the sensor data acquiring unit 11, thereby generates the replacement data, and replaces the noise portion of the sensor data in which it is determined by the noise determination unit 12 that noise occurs with the generated replacement data. As a result, the sensor noise removal device 1 can convert the sensor data whose reliability is lowered by noise into the sensor data in a state where no noise occurs.

Furthermore, in the sensor noise removal device 1, the data replacement unit 13 estimates whether or not an object is detected in the noise portion of the sensor data in which it is determined by the noise determination unit 12 that noise occurs, on the basis of the sensor data in which it is determined by the noise determination unit 12 that no noise occurs. In the case of estimating that the object is detected, the data replacement unit 13 generates the replacement data as data that indicates the position of the object, the type of the object, or the orientation of the object. Therefore, the sensor noise removal device 1 can convert the sensor data whose reliability is lowered by noise into the sensor data in a state where no noise occurs in such a manner that the object appears, in a case where it is estimated that the object is detected in the noise portion on the basis of the sensor data in which it is determined that no noise occurs.

In addition, in the sensor noise removal device 1, the data replacement unit 13 estimates the sensor data in which no noise occurs on the basis of the sensor data in which it is determined by the noise determination unit 12 that noise occurs, thereby generates the replacement data, and replaces the noise portion of the sensor data in which it is determined by the noise determination unit 12 that noise occurs with the generated replacement data. As a result, the sensor noise removal device 1 can convert the sensor data whose reliability is lowered by noise into the sensor data in a state where no noise occurs.

Furthermore, in the sensor noise removal device 1, the noise determination unit 12 determines whether or not noise occurs in the sensor data acquired by the sensor data acquiring unit 11 on the basis of the characteristics of the sensor data. As a result, the sensor noise removal device 1 can convert the sensor data whose reliability is lowered by noise into the sensor data in a state where no noise occurs in consideration of the characteristics of the sensor data.

### Second Embodiment

In addition to the functions described in the first embodiment, the sensor noise removal device may have a function of detecting an object on the basis of acquired sensor data and determining the validity of an object detected in a plurality of pieces of sensor data.

In a second embodiment, an embodiment having the function of determining the validity of an object detected in a plurality of pieces of sensor data will be described.

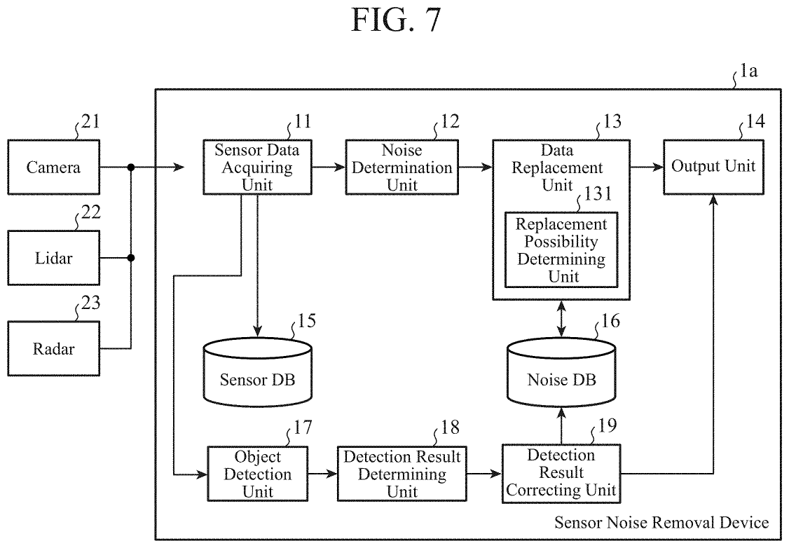

FIG. 7 is a diagram illustrating a configuration example of a sensor noise removal device 1a according to the second embodiment.

Similarly to the sensor noise removal device 1 according to the first embodiment, the sensor noise removal device 1a according to the second embodiment is mounted on a vehicle, and is connected to the camera 21, the lidar 22, and the radar 23.

In FIG. 7, the same reference numerals are given to components similar to those of the sensor noise removal device 1 described in the first embodiment with reference to FIG. 1, and redundant description will be omitted.

The sensor noise removal device 1a according to the second embodiment is different from the sensor noise removal device 1 according to the first embodiment in that it includes an object detection unit 17, a detection result determining unit 18, and a detection result correcting unit 19.

The object detection unit 17 detects an object in each piece of sensor data acquired by the sensor data acquiring unit 11. In the second embodiment, the object detection unit 17 detects an object in each of a captured image, first distance data, and second distance data acquired by the sensor data acquiring unit 11.

The object detection unit 17 may detect an object using a known technique.

The object detection unit 17 outputs information related to the detection result of the object (hereinafter, referred to as “object-detection result information”) to the detection result determining unit 18 for each piece of sensor data. The object-detection result information includes information enabling identification of at least sensor data in which an object has been detected, a position of the detected object, a type of the object, and an orientation of the object.

The detection result determining unit 18 determines the validity of the detection result of the object by the object detection unit 17 on the basis of the object-detection result information output from the object detection unit 17.

For example, it is assumed that there is a car on which a person is drawn in the object detection area of the camera 21, the lidar 22, and the radar 23. It is assumed that the object detection unit 17 detects a person on the basis of a captured image, detects a car on the basis of the first distance data, and detects a car on the basis of the second distance data.

For example, the detection result determining unit 18 determines that the validity of the detection result in which a car is detected in the first distance data and the second distance data is high and the validity of the detection result in which a person is detected in the captured image is low, on the basis of the fact that a car is detected from the first distance data and the second distance data whereas a person is detected from the captured image.

In this manner, the detection result determining unit 18 compares objects detected from a plurality of pieces of sensor data, and for example, in a case where an object detected from a certain piece of sensor data is different from objects detected from a plurality of pieces of other sensor data, determines that the validity of the detection result of the object based on the certain piece of sensor data is low. At that time, the objects detected from the plurality of pieces of other sensor data are the same.

For example, in a case where all the objects detected from the plurality of pieces of sensor data are different, the detection result determining unit 18 determines that the detection result of the object is indeterminable. For example, it is assumed in the above example that the object detection unit 17 detects a person on the basis of the captured image, detects a car on the basis of the first distance data, and detects a signboard on the basis of the second distance data. In this case, the detection result determining unit 18 determines that the detection result of the object is indeterminable.

For example, in a case where the ratio of the number of detections of a certain object to the number of all objects detected from a plurality of pieces of sensor data is equal to or larger than a preset threshold, the detection result determining unit 18 may determine that the validity of the detection result of the certain object is high.

Furthermore, the detection result determining unit 18 may determine the validity of the detection result of the object by comparing the types of the detected objects. For example, it is assumed that the object detection unit 17 detects a truck on the basis of the captured image, detects a kei car on the basis of the first distance data, and detects a kei car on the basis of the second distance data. In this case, the object detection unit 17 determines that the validity of the detection result of the object based on the captured image is low, and determines that the validity of the detection result of the object based on the first distance data and the second distance data is high.

The detection result determining unit 18 attaches information related to whether it is determined that the validity of the detection result of the object is high, low, or indeterminable (hereinafter, referred to as “validity-determination result information”) to the object-detection result information output from the object detection unit 17, and outputs the resultant information to the detection result correcting unit 19.

On the basis of the validity-determination result information attached to the object-detection result information output from the detection result determining unit 18, the detection result correcting unit 19 corrects the detection result of the object determined to be low in validity by the detection result determining unit 18 to the detection result of the object determined to be high in validity by the detection result determining unit 18.

As a specific example, for example, it is assumed that a person is detected in object-detection result information related to a captured image, and the validity is low in validity-determination result information attached to the object-detection result information. In addition, it is assumed that a car is detected in object-detection result information related to the first distance data and the second distance data, and the validity is high in validity-determination result information attached to the object-detection result information. In this case, the detection result correcting unit 19 corrects the information related to the detected object in the object-detection result information related to the captured image from the information related to the person to the information related to the car set in the object-detection result information related to the first distance data and the second distance data. At that time, the detection result correcting unit 19 attaches information which enables identification of the correction of the information related to the detected object in the object-detection result information related to the captured image.

The detection result correcting unit 19 outputs, to the output unit 14, the object-detection result information determined to be high in validity and the object-detection result information obtained by correcting the information related to the detected object although determined to be low in validity.

The detection result correcting unit 19 stores, in the noise DB 16, the object-detection result information whose detection result of the object is indeterminable.

The output unit 14 outputs the object-detection result information output from the detection result correcting unit 19. It is assumed that the output destination device to which the output unit 14 outputs the object-detection result information is determined in advance.

An operation of the sensor noise removal device 1a according to the second embodiment will be described.

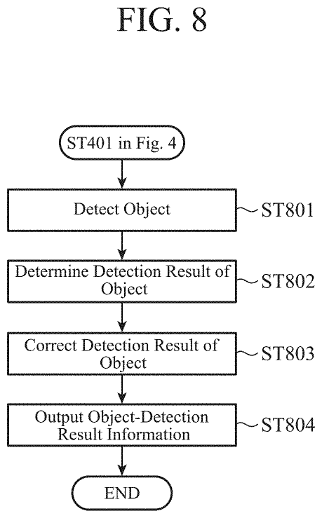

FIG. 8 is a flowchart for describing the operation of the sensor noise removal device 1a according to the second embodiment.

The sensor noise removal device 1a according to the second embodiment performs an operation described with reference to the flowchart of FIG. 8 below in addition to the operation of the sensor noise removal device 1 described in the first embodiment with reference to FIGS. 4 and 5. The operation described in the first embodiment with reference to FIGS. 4 and 5 will not be described repeatedly.

Note that the operations of steps ST402 to ST404 in FIG. 4 and the operations of steps ST801 to ST804 in FIG. 8 may be performed in parallel.

The object detection unit 17 acquires sensor data acquired by the sensor data acquiring unit 11 (see step ST401 in FIG. 4), and detects an object in each acquired piece of sensor data (step ST801).

The object detection unit 17 outputs object-detection result information related to the detection result of the object to the detection result determining unit 18 for each piece of sensor data.

The detection result determining unit 18 determines the validity of the detection result of the object by the object detection unit 17 on the basis of the object-detection result information output from the object detection unit 17 in step ST801 (step ST802).

The detection result determining unit 18 attaches validity-determination result information related to whether it is determined that the validity of the detection result of the object is high, low, or indeterminable to the object-detection result information output from the object detection unit 17, and outputs the resultant information to the detection result correcting unit 19.

On the basis of the validity-determination result attached to the object-detection result information output from the detection result determining unit 18 in step ST802, the detection result correcting unit 19 corrects the detection result of the object determined to be low in validity by the detection result determining unit 18 to the detection result of the object determined to be high in validity by the detection result determining unit 18 (step ST803).

The detection result correcting unit 19 outputs, to the output unit 14, the object-detection result information determined to be high in validity and the object-detection result information obtained by correcting the information related to the detected object although determined to be low in validity.

The detection result correcting unit 19 stores, in the noise DB 16, the object-detection result information whose detection result of the object is indeterminable.

The output unit 14 outputs the object-detection result information output from the detection result correcting unit 19 in step ST803 (step ST804).

As described above, the sensor noise removal device 1a detects an object in each of the plurality of pieces of acquired sensor data, and determines the validity of the detection result of the object. When determining that the validity of the detection result of the object is low, the sensor noise removal device 1a corrects the detection result of the object determined to be low in validity to the detection result of the object determined to be high in validity.

The sensor noise removal device 1a can detect an error in object detection by utilizing other sensor data.

Note that, in the second embodiment described above, the object detection unit 17 performs object detection processing on the sensor data acquired by the sensor data acquiring unit 11 before the noise determination unit 12 determines noise, but this is merely an example. For example, the object detection unit 17 may perform the object detection processing on the sensor data in which it is determined that no noise occurs as a result of the noise determination performed by the noise determination unit 12, or may perform the object detection processing on the sensor data output from the data replacement unit 13 after the replacement is performed by the data replacement unit 13.

Since the hardware configuration of the sensor noise removal device 1a according to the second embodiment is similar to the hardware configuration of the sensor noise removal device 1 described in the first embodiment with reference to FIGS. 6A and 6B, illustration thereof is omitted.

In the second embodiment, the functions of the sensor data acquiring unit 11, the noise determination unit 12, the data replacement unit 13, the output unit 14, the object detection unit 17, the detection result determining unit 18, and the detection result correcting unit 19 are implemented by the processing circuit 601. That is, the sensor noise removal device 1a includes the processing circuit 601 that, in a case where noise occurs in the acquired sensor data, executes control to estimate sensor data in which no noise occurs for the sensor data in which the noise occurs, thereby generate replacement data corresponding to the noise portion, replace the noise portion with the generated replacement data, detect an object on the basis of the sensor data, and determine the validity of the detected object.

By reading and executing the program stored in the memory 605, the processing circuit 601 performs the functions of the sensor data acquiring unit 11, the noise determination unit 12, the data replacement unit 13, the output unit 14, the object detection unit 17, the detection result determining unit 18, and the detection result correcting unit 19. That is, the sensor noise removal device 1a includes the memory 605 for storing a program that results in steps ST401 to ST404 in FIG. 4 and steps ST801 to ST804 in FIG. 8 being performed when executed by the processing circuit 601. It can also be said that the program stored in the memory 605 causes a computer to perform the procedures or methods implemented by the sensor data acquiring unit 11, the noise determination unit 12, the data replacement unit 13, the output unit 14, the object detection unit 17, the detection result determining unit 18, and the detection result correcting unit 19.

The sensor noise removal device 1a includes the input interface device 602 and the output interface device 603 that perform wired communication or wireless communication with a device such as the camera 21, the lidar 22, or the radar 23.

As described above, according to the second embodiment, the sensor noise removal device 1a includes: the object detection unit 17 that detects an object in each of the plurality of pieces of sensor data acquired by the sensor data acquiring unit 11; the detection result determining unit 18 that determines the validity of the detection result of the object by the object detection unit 17; and the detection result correcting unit 19 that corrects the detection result determined to be low in validity by the detection result determining unit 18 to the detection result determined to be high in validity by the detection result determining unit 18.

As a result, the sensor noise removal device 1a can convert the sensor data whose reliability is lowered by noise into the sensor data in a state where no noise occurs, and can detect an error in object detection by utilizing other sensor data.

### Third Embodiment

In the first embodiment, the sensor noise removal device determines whether or not noise occurs in sensor data using a known technique. In addition, the sensor noise removal device performs replacement on the basis of a predetermined rule in the first replacement function or the second replacement function. Specifically, for example, in the first replacement function, the sensor noise removal device generates, for a pixel included in a noise portion, replacement data from a neighboring pixel in which no noise occurs, and replaces the pixel in the noise portion with the generated replacement data. In addition, for example, in the second replacement function, the sensor noise removal device estimates whether an object is detected in the noise portion from the first distance data or the second distance data in which no noise occurs, generates replacement data in such a manner that the object estimated to have been detected in the noise portion on the basis of the estimation result appears, and replaces the pixel in the noise portion with the generated replacement data.

In a third embodiment, an embodiment in which a sensor noise removal device performs noise determination and replacement on the basis of a trained model in machine learning (hereinafter, referred to as “machine learning model”) will be described.

Similarly to the sensor noise removal device 1 according to the first embodiment, a sensor noise removal device 1b according to the third embodiment is mounted on a vehicle, and is connected to the camera 21, the lidar 22, and the radar 23. The sensor noise removal device 1b according to the third embodiment is further connected to a learning device 3. Details of the learning device 3 will be described later.

Also in the third embodiment, similarly to the first embodiment, it is assumed that the captured image acquired from the camera 21 cannot be substituted with the first distance data acquired from the lidar 22 or the second distance data acquired from the radar 23 when processing using the captured image is performed.

In addition, it is assumed that an event causing noise may occur in the camera 21. It is assumed that no event causing noise occurs in the lidar 22 and the radar 23. That is, it is assumed that no noise occurs in the first distance data and the second distance data.

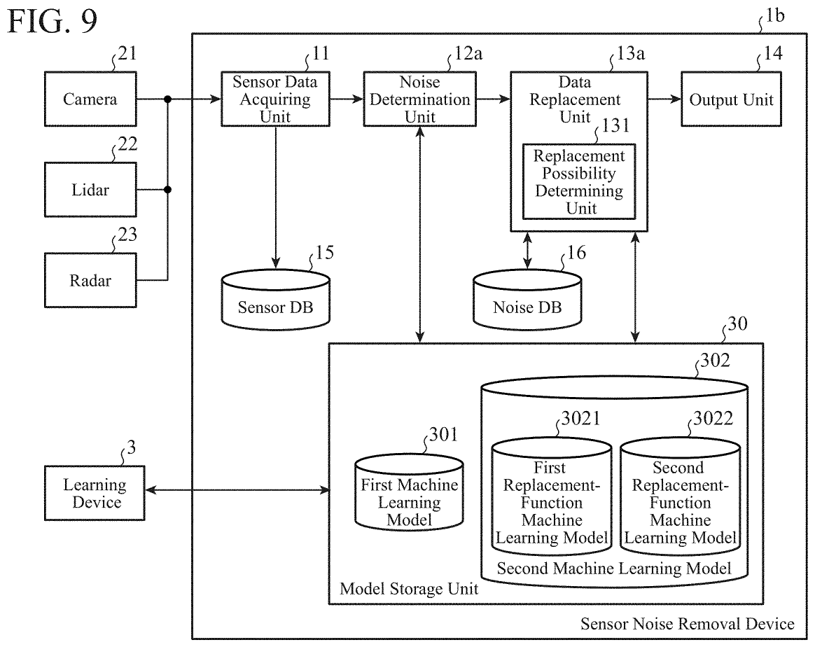

FIG. 9 is a diagram illustrating a configuration example of the sensor noise removal device 1b according to the third embodiment.

In the configuration of the sensor noise removal device 1b according to the third embodiment, the same reference numerals are given to the same components as those of the sensor noise removal device 1 described in the first embodiment with reference to FIG. 1, and redundant description will be omitted.

The sensor noise removal device 1b according to the third embodiment is different from the sensor noise removal device 1 according to the first embodiment in that it includes a model storage unit 30.

In addition, specific operations of a noise determination unit 12a and a data replacement unit 13a in the sensor noise removal device 1b according to the third embodiment are different from specific operations of the noise determination unit 12 and the data replacement unit 13 in the sensor noise removal device 1 according to the first embodiment.

The model storage unit 30 of the sensor noise removal device 1b stores a first machine learning model 301 and a second machine learning model 302. The second machine learning model 302 includes a first replacement-function machine learning model 3021 and a second replacement-function machine learning model 3022.

The first machine learning model 301 is a machine learning model that receives sensor data as an input and outputs information indicating whether or not noise occurs in the sensor data.

The first replacement-function machine learning model 3021 is a machine learning model that receives sensor data in which noise occurs as an input and outputs sensor data in which a noise portion of the sensor data in which noise occurs has been replaced with sensor data in which no noise occurs.

The second replacement-function machine learning model 3022 is a machine learning model that receives, as inputs, sensor data in which noise occurs and sensor data in which no noise occurs and outputs sensor data in which a noise portion of the sensor data in which noise occurs has been replaced with the sensor data in which no noise occurs.

The first machine learning model 301 and the second machine learning model 302 stored in the model storage unit 30 are generated by the learning device 3. Details of the learning device 3 will be described later.

Note that, here, as illustrated in FIG. 9, the model storage unit 30 is provided in the sensor noise removal device 1b, but this is merely an example. For example, the model storage unit 30 may be provided at a place that is outside the sensor noise removal device 1b and that can be referred to by the sensor noise removal device 1b.

The noise determination unit 12a determines whether or not noise occurs in the sensor data acquired by the sensor data acquiring unit 11, by using the first machine learning model 301. Specifically, in the third embodiment, the noise determination unit 12a determines whether or not noise occurs in a captured image acquired by the sensor data acquiring unit 11, by using the first machine learning model 301.

For the sensor data in which it is determined by the noise determination unit 12a that noise occurs, the data replacement unit 13a acquires sensor data in which a noise portion of the sensor data has been replaced with sensor data in which no noise occurs, by using the second machine learning model 302. In this manner, the data replacement unit 13a replaces the sensor data in which it is determined by the noise determination unit 12a that noise occurs. In the third embodiment, the data replacement unit 13a acquires, for a captured image in which it is determined by the noise determination unit 12 that noise occurs, a captured image in which a noise portion has been replaced with pixels in which no noise occurs.

More specifically, in a case where the replacement possibility determining unit 131 outputs information indicating that replacement can be performed using only the sensor data in which it is determined by the noise determination unit 12 that noise occurs, in other words, the captured image, the data replacement unit 13a acquires, for the sensor data in which it is determined by the noise determination unit 12a that noise occurs, sensor data in which the noise portion of the sensor data has been replaced with sensor data in which no noise occurs by using the first replacement-function machine learning model 3021.

Furthermore, in a case where the replacement possibility determining unit 131 outputs information indicating that replacement can be performed on the basis of the sensor data in which it is determined by the noise determination unit 12 that no noise occurs, in other words, the first distance data or the second distance data, the data replacement unit 13a acquires, for the sensor data in which it is determined by the noise determination unit 12a that noise occurs, sensor data in which the noise portion of the sensor data has been replaced with sensor data in which no noise occurs by using the second replacement-function machine learning model 3022.

The operation of the sensor noise removal device 1b according to the third embodiment will be described later. Next, a configuration example of the learning device 3 according to the third embodiment will be described.

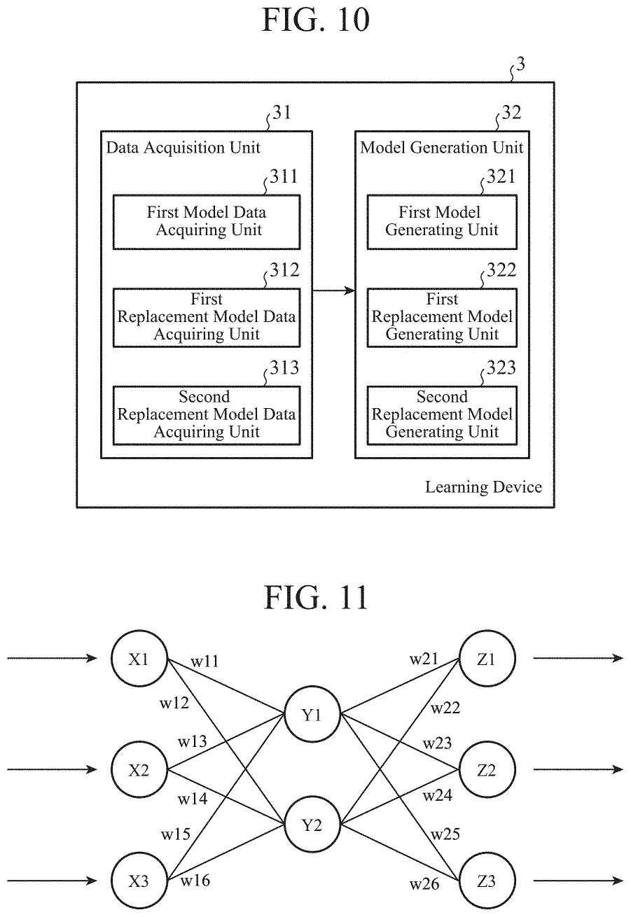

FIG. 10 is a diagram illustrating the configuration example of the learning device 3 according to the third embodiment.

As illustrated in FIG. 9, the learning device 3 is connected to the sensor noise removal device 1b.

The learning device 3 generates the first machine learning model 301 and the second machine learning model 302 by so-called supervised learning using teacher data. Specifically, the second machine learning model 302 includes the first replacement-function machine learning model 3021 and the second replacement-function machine learning model 3022.

The learning device 3 includes a data acquisition unit 31 and a model generation unit 32.

The data acquisition unit 31 includes a first model data acquiring unit 311, a first replacement model data acquiring unit 312, and a second replacement model data acquiring unit 313.

The model generation unit 32 includes a first model generating unit 321, a first replacement model generating unit 322, and a second replacement model generating unit 323.

The data acquisition unit 31 acquires training data.

The first model data acquiring unit 311 of the data acquisition unit 31 acquires training data for generating the first machine learning model 301 (hereinafter, referred to as “first model training data”).

The first model training data is data in which sensor data and a teacher label are associated with each other. The teacher label is information indicating whether or not noise occurs. The sensor data includes sensor data in which noise occurs and sensor data in which no noise occurs. A large amount of first model training data is prepared in advance by an administrator or the like.

The first replacement model data acquiring unit 312 of the data acquisition unit 31 acquires training data for generating the first replacement-function machine learning model 3021 (hereinafter, referred to as “first replacement model training data”).

The first replacement model training data is data in which sensor data in which noise occurs is associated with a teacher label. Note that the sensor data in which noise occurs may include, for example, sensor data in which it is assumed that noise has occurred due to the influence of the environment or the like, in addition to sensor data in which it is assumed that noise has occurred due to the occurrence of an event causing noise in the sensor. The teacher label is sensor data generated by converting a noise portion of the associated sensor data into a portion in a state where no noise occurs. A large amount of first replacement model training data is prepared in advance by an administrator or the like.

The second replacement model data acquiring unit 313 of the data acquisition unit 31 acquires training data for generating the second replacement-function machine learning model 3022 (hereinafter, referred to as “second replacement model training data”).

The second replacement model training data is data in which sensor data in which noise occurs, sensor data that is different from the sensor data and in which no noise occurs, and a teacher label are associated with each other. The teacher label is sensor data generated by converting a noise portion of the sensor data in which noise occurs into a portion in a state where no noise occurs. A large amount of second replacement model training data is prepared in advance by an administrator or the like. Note that the sensor data in which noise occurs and the sensor data in which no noise occurs are acquired for the same detection area under the same situation.

The data acquisition unit 31 outputs the acquired training data to the model generation unit 32. Specifically, the data acquisition unit 31 outputs the first model training data acquired by the first model data acquiring unit 311, the first replacement model training data acquired by the first replacement model data acquiring unit 312, and the second replacement model training data acquired by the second replacement model data acquiring unit 313 to the model generation unit 32.

Note that, for each of the first model training data, the first replacement model training data, and the second replacement model training data, on the basis of the type of sensor data included in the training data, the data acquisition unit 31 makes it possible to recognize the type of sensor data for which the training data is generated.

The model generation unit 32 generates the first machine learning model 301, the first replacement-function machine learning model 3021, and the second replacement-function machine learning model 3022.

The first model generating unit 321 of the model generation unit 32 generates the first machine learning model 301 that receives the first model training data output from the data acquisition unit 31 as an input and outputs information as to whether or not noise occurs by using a neural network.

When generating the first machine learning model 301, the first model generating unit 321 performs preprocessing such as feature amount extraction on the first model training data. Specifically, for example, in a case where the sensor data is a captured image, the first model generating unit 321 divides the captured image into images in units of one pixel. In addition, for example, the first model generating unit 321 attaches a label indicating object detection or the like. Note that this preprocessing may be performed by the first model data acquiring unit 311, and the first model data acquiring unit 311 may output the preprocessed data to the model generation unit 32 as training data.

The neural network includes an input layer including a plurality of neurons, an intermediate layer (hidden layer) including a plurality of neurons, and an output layer including a plurality of neurons. The intermediate layer may be a single layer or two or more layers.

FIG. 11 is a diagram for describing an example of the neural network.

For example, in the case of a three-layer neural network illustrated in FIG. 11, when a plurality of inputs are input to input layers (X1-X3), the values are multiplied by weights W1 (w11-w16) and input to intermediate layers) Y1-Y2), and the results are further multiplied by weights W2 (w21-w26) and output from output layers (Z1-Z3). The output result varies depending on the values of the weights W1 and W2.

In the third embodiment, the first model generating unit 321 causes the first machine learning model 301 configured by the neural network described above to learn by so-called supervised learning on the basis of the first model training data.

The first machine learning model 301 learns by adjusting the weights W1 and W2 in such a manner that more correct answers are output from the output layer.

The first model generating unit 321 generates the first machine learning model 301 as described above, and outputs the first machine learning model to the model storage unit 30 (see FIG. 9).

Note that the first model generating unit 321 generates the first machine learning model 301 for the type of sensor data included in the first model training data, and makes it possible to recognize the type of sensor data for which the generated first machine learning model 301 is generated.

The first replacement model generating unit 322 generates the first replacement-function machine learning model 3021 that receives the first replacement model training data output from the data acquisition unit 31 as an input and outputs sensor data in which a noise portion of sensor data in which noise occurs has been replaced with sensor data in which no noise occurs by using a neural network.

When generating the first replacement-function machine learning model 3021, the first replacement model generating unit 322 performs preprocessing such as feature amount extraction on the first replacement model training data. Specifically, for example, in a case where the sensor data is a captured image, the first replacement model generating unit 322 divides the captured image into images in units of one pixel. In addition, for example, the first replacement model generating unit 322 attaches a label indicating object detection or the like. Note that this preprocessing may be performed by the first replacement model data acquiring unit 312, and the first replacement model data acquiring unit 312 may output the preprocessed data to the model generation unit 32 as training data.

In the third embodiment, the first replacement model generating unit 322 causes the first replacement-function machine learning model 3021 configured by the neural network described above (see FIG. 11) to learn by so-called supervised learning on the basis of the first replacement model training data.

The first replacement-function machine learning model 3021 learns by adjusting the weights W1 and W2 in such a manner that more correct answers are output from the output layer.

The concept of the first replacement-function machine learning model 3021 is to convert noise occurring in the sensor data into sensor data in a state where the noise does not occur. Specifically, for example, it is assumed that noise occurs in a captured image captured by the camera 21. The first replacement-function machine learning model 3021 receives the captured image in which noise occurs as an input, and outputs a captured image in a state where the noise does not occur.

The first replacement model generating unit 322 generates the first replacement-function machine learning model 3021 as described above, and outputs the first replacement-function machine learning model to the model storage unit 30 (see FIG. 9).

Note that the first replacement model generating unit 322 generates the first replacement-function machine learning model 3021 for the type of sensor data in which noise occurs and which is included in the first replacement model training data, and makes it possible to recognize the type of sensor data for which the generated first replacement-function machine learning model 3021 is generated.

The second replacement model generating unit 323 generates the second replacement-function machine learning model 3022 that receives the second replacement model training data output from the data acquisition unit 31 as an input and outputs sensor data in which a noise portion of sensor data in which noise occurs has been replaced with sensor data in which no noise occurs by using a neural network.

When generating the second replacement-function machine learning model 3022, the second replacement model generating unit 323 performs preprocessing such as feature amount extraction on the second replacement model training data. Specifically, for example, in a case where the sensor data is a captured image, the second replacement model generating unit 323 divides the captured image into images in units of one pixel. In addition, for example, the second replacement model generating unit 323 attaches a label indicating object detection or the like. Note that this preprocessing may be performed by the second replacement model data acquiring unit 313, and the second replacement model data acquiring unit 313 may output the preprocessed data to the model generation unit 32 as training data.

In the third embodiment, the second replacement model generating unit 323 causes the second replacement-function machine learning model 3022 configured by the neural network described above (see FIG. 11) to learn by so-called supervised learning on the basis of the second replacement model training data.

The second replacement-function machine learning model 3022 learns by adjusting the weights W1 and W2 in such a manner that more correct answers are output from the output layer.

The concept of the second replacement-function machine learning model 3022 is to convert noise occurring in the sensor data into sensor data in a state where the noise does not occur, on the basis of other sensor data. Specifically, for example, it is assumed that the sensor data includes a captured image captured by the camera 21, first distance data acquired by the lidar 22, and second distance data acquired by the radar 23. It is assumed that noise occurs in the captured image. No noise occurs in the first distance data and the second distance data. In this case, the second replacement-function machine learning model 3022 receives the captured image in which noise occurs and the first distance data and the second distance data in which no noise occurs as inputs, and outputs a captured image in a state where no noise occurs.

The second replacement model generating unit 323 generates the second replacement-function machine learning model 3022 as described above, and outputs the second replacement-function machine learning model to the model storage unit 30 (see FIG. 9).

Note that the second replacement model generating unit 323 generates the second replacement-function machine learning model 3022 for the type of sensor data in which noise occurs and which is included in the second replacement model training data, and makes it possible to recognize the type of sensor data for which the generated second replacement-function machine learning model 3022 is generated.

An operation of the sensor noise removal device 1b according to the third embodiment will be described.

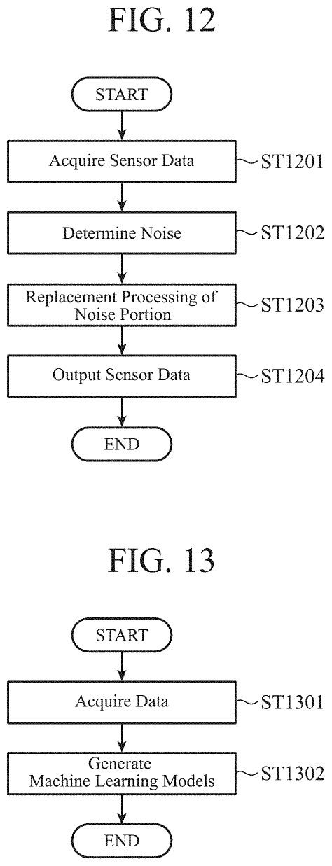

FIG. 12 is a flowchart for describing the operation of the sensor noise removal device 1b according to the third embodiment.

The sensor data acquiring unit 11 acquires sensor data related to the surrounding situation of the vehicle (step ST1201). Specifically, the sensor data acquiring unit 11 acquires the captured image captured by the camera 21, the first distance data acquired by the lidar 22, and the second distance data acquired by the radar 23.

The sensor data acquiring unit 11 outputs the acquired captured image, the first distance data, and the second distance data to the noise determination unit 12.

The sensor data acquiring unit 11 also stores the acquired captured image, the first distance data, and the second distance data in the sensor DB 15.

The noise determination unit 12a determines whether or not noise occurs in the sensor data acquired by the sensor data acquiring unit 11 in step ST1201 (step ST1202).

Specifically, the noise determination unit 12a determines whether or not noise occurs in the sensor data acquired by the sensor data acquiring unit 11, by using the first machine learning model 301. In the third embodiment, the noise determination unit 12a determines whether or not noise occurs in the captured image acquired by the sensor data acquiring unit 11, by using the first machine learning model 301.

The noise determination unit 12a outputs the captured image acquired from the sensor data acquiring unit 11 to the data replacement unit 13a together with a determination result as to whether or not noise is included. At that time, the noise determination unit 12a also outputs the first distance data and the second distance data acquired from the sensor data acquiring unit 11 to the data replacement unit 13a.

The data replacement unit 13a replaces the sensor data in which it is determined by the noise determination unit 12a that noise occurs in step ST1202 with sensor data in which no noise occurs (step ST1203).

Specifically, for the sensor data in which it is determined by the noise determination unit 12a that noise occurs, the data replacement unit 13a acquires sensor data in which a noise portion of the sensor data has been replaced with sensor data in which no noise occurs, by using the second machine learning model 302. In the third embodiment, the data replacement unit 13a acquires, for a captured image in which it is determined by the noise determination unit 12 that noise occurs, a captured image in which a noise portion has been replaced with pixels in which no noise occurs.

More specifically, in a case where the replacement possibility determining unit 131 outputs information indicating that replacement can be performed using only the sensor data in which it is determined by the noise determination unit 12a that noise occurs, in other words, the captured image, the data replacement unit 13a acquires, for the captured image in which it is determined by the noise determination unit 12a that noise occurs, an after-replacement captured image in which the noise portion of the captured image has been replaced with pixels in which no noise occurs, by using the first replacement-function machine learning model 3021.

Furthermore, in a case where the replacement possibility determining unit 131 outputs information indicating that replacement can be performed on the basis of the sensor data in which it is determined by the noise determination unit 12a that no noise occurs, in other words, the first distance data or the second distance data, the data replacement unit 13a acquires, for the captured image in which it is determined by the noise determination unit 12a that noise occurs, an after-replacement captured image in which the noise portion of the captured image has been replaced with pixels in which no noise occurs, by using the second replacement-function machine learning model 3022.

When performing replacement on the captured image, the data replacement unit 13a outputs the after-replacement captured image to the output unit 14. In a case where no replacement is performed on the captured image, the data replacement unit 13a outputs the captured image acquired by the sensor data acquiring unit 11 to the output unit 14. In addition, the data replacement unit 13 outputs the first distance data and the second distance data acquired by the sensor data acquiring unit 11 to the output unit 14.

The output unit 14 outputs the sensor data output from the data replacement unit 13a in step ST1203 (step ST1204). Specifically, the output unit 14 outputs the after-replacement captured image or the captured image, the first distance data, and the second distance data output from the data replacement unit 13.

An operation of the learning device 3 according to the third embodiment will be described.

FIG. 13 is a flowchart for describing the operation of the learning device 3 according to the third embodiment.

The data acquisition unit 31 acquires training data (step ST1301).

The first model data acquiring unit 311 of the data acquisition unit 31 acquires first model training data. The first replacement model data acquiring unit 312 of the data acquisition unit 31 acquires first replacement model training data. The second replacement model data acquiring unit 313 of the data acquisition unit 31 acquires second replacement model training data.

The data acquisition unit 31 outputs the acquired training data to the model generation unit 32.

The model generation unit 32 generates the first machine learning model 301, the first replacement-function machine learning model 3021, and the second replacement-function machine learning model 3022 (step ST1302).

Specifically, the first model generating unit 321 of the model generation unit 32 generates the first machine learning model 301 that receives the first model training data output from the data acquisition unit 31 in step ST1301 as an input and outputs information as to whether or not noise occurs. The first model generating unit 321 outputs the generated first machine learning model 301 to the model storage unit 30.

The first replacement model generating unit 322 of the model generation unit 32 generates the first replacement-function machine learning model 3021 that receives the first replacement model training data output from the data acquisition unit 31 in step ST1301 as an input and outputs sensor data in which a noise portion of sensor data in which noise occurs has been replaced with sensor data in which no noise occurs. The first replacement model generating unit 322 outputs the generated first replacement-function machine learning model 3021 to the model storage unit 30.

The second replacement model generating unit 323 of the model generation unit 32 generates the second replacement-function machine learning model 3022 that receives the second replacement model training data output from the data acquisition unit 31 in step ST1301 as an input and outputs sensor data in which a noise portion of sensor data in which noise occurs has been replaced with sensor data in which no noise occurs. The second replacement model generating unit 323 outputs the generated second replacement-function machine learning model 3022 to the model storage unit 30.

Since the hardware configuration of the sensor noise removal device 1b according to the third embodiment is similar to the hardware configuration of the sensor noise removal device 1 described in the first embodiment with reference to FIGS. 6A and 6B, illustration thereof is omitted.

In the third embodiment, the functions of the sensor data acquiring unit 11, the noise determination unit 12a, the data replacement unit 13a, and the output unit 14 are implemented by the processing circuit 601. That is, the sensor noise removal device 1b includes the processing circuit 601 that, in a case where noise occurs in the acquired sensor data, executes control to acquire sensor data in which no noise occurs for the sensor data in which the noise occurs by using the first machine learning model 301, the first replacement-function machine learning model 3021, or the second replacement-function machine learning model 3022.

By reading and executing the program stored in the memory 605, the processing circuit 601 performs the functions of the sensor data acquiring unit 11, the noise determination unit 12a, the data replacement unit 13a, and the output unit 14. That is, the sensor noise removal device 1b includes the memory 605 for storing a program that results in steps ST1201 to ST1204 in FIG. 12 being performed when executed by the processing circuit 601. It can also be said that the program stored in the memory 605 causes a computer to perform the procedures or methods implemented by the sensor data acquiring unit 11, the noise determination unit 12a, the data replacement unit 13a, and the output unit 14.

Furthermore, the sensor DB 15, the noise DB 16, and the model storage unit 30 use the memory 605. Note that this is an example, and the sensor DB 15 and the noise DB 16 may be configured by an HDD, a solid state drive (SSD), a DVD, or the like.

The sensor noise removal device 1b includes the input interface device 602 and the output interface device 603 that perform wired communication or wireless communication with a device such as the camera 21, the lidar 22, the radar 23, or the learning device 3.

The learning device 3 according to the third embodiment has a hardware configuration similar to that of the sensor noise removal device 1 according to the first embodiment (see FIGS. 6A and 6B).

In the third embodiment, the functions of the data acquisition unit 31 and the model generation unit 32 are implemented by the processing circuit 601. That is, the learning device 3 includes the processing circuit 601 for generating the first machine learning model 301, the first replacement-function machine learning model 3021, and the second replacement-function machine learning model 3022 on the basis of the acquired training data.

The processing circuit 601 may be dedicated hardware as illustrated in FIG. 6A, or may be the central processing unit (CPU) 604 that executes a program stored in the memory 605 as illustrated in FIG. 6B.

In a case where the processing circuit 601 is dedicated hardware, the processing circuit 601 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit 601 is the CPU 604, the functions of the data acquisition unit 31 and the model generation unit 32 are implemented by software, firmware, or a combination of software and firmware. The software or firmware is described as a program and stored in the memory 605. By reading and executing the program stored in the memory 605, the processing circuit 601 performs the functions of the data acquisition unit 31 and the model generation unit 32. That is, the learning device 3 includes the memory 605 for storing a program that results in steps ST1301 to ST1302 in FIG. 13 being performed when executed by the processing circuit 601. It can also be said that the program stored in the memory 605 causes a computer to perform the procedures or methods implemented by the data acquisition unit 31 and the model generation unit 32. Here, the memory 605 corresponds to, for example, a nonvolatile or volatile semiconductor memory such as a RAM, a read only memory (ROM), a flash memory, an erasable programmable read only memory (EPROM), or an electrically erasable programmable read only memory (EEPROM), a magnetic disk, a flexible disk, an optical disk, a compact disk, a mini disk, a digital versatile disc (DVD), or the like.

Note that a part of the functions of the data acquisition unit 31 and the model generation unit 32 may be implemented by dedicated hardware, whereas another part thereof may be implemented by software or firmware. For example, the function of the data acquisition unit 31 can be implemented by the processing circuit 601 as dedicated hardware, and the function of the model generation unit 32 can be implemented by the processing circuit 601 reading and executing a program stored in the memory 605.

Furthermore, the learning device 3 includes the input interface device 602 and the output interface device 603 that perform wired communication or wireless communication with a device such as the sensor noise removal device 1b.

In the third embodiment described above, the learning device 3 is provided outside the sensor noise removal device 1b and is connected to the sensor noise removal device 1b via a network, but this is merely an example.

The learning device 3 may be provided in the sensor noise removal device 1b.

In the third embodiment described above, the data replacement unit 13a has a function of acquiring sensor data in which no noise occurs by using the first replacement-function machine learning model 3021 and a function of acquiring sensor data in which no noise occurs by using the second replacement-function machine learning model 3022, but this is merely an example. The data replacement unit 13a may have either the function of acquiring sensor data in which no noise occurs by using the first replacement-function machine learning model 3021 or the function of acquiring sensor data in which no noise occurs by using the second replacement-function machine learning model 3022.

In a case where the data replacement unit 13a has only the function of acquiring sensor data in which no noise occurs by using the first replacement-function machine learning model 3021, the replacement possibility determining unit 131 only determines whether or not the first replaceable condition is satisfied. Note that, in this case, the learning device 3 does not have to generate the second replacement-function machine learning model 3022.

In addition, in a case where the data replacement unit 13a has only the function of acquiring sensor data in which no noise occurs by using the second replacement-function machine learning model 3022, the replacement possibility determining unit 131 only determines whether or not the second replaceable condition is satisfied. Note that, in this case, the learning device 3 does not have to generate the first replacement-function machine learning model 3021.

Furthermore, in the second embodiment described above, the data replacement unit 13a includes the replacement possibility determining unit 131, but the replacement possibility determining unit 131 is not essential. For example, the data replacement unit 13a may have the function of the replacement possibility determining unit 131, and the data replacement unit 13a may determine whether or not the replaceable condition is satisfied when performing replacement.

Furthermore, it is assumed in the third embodiment described above that noise may occur in the captured image, but this is merely an example. In the third embodiment, it may be assumed that noise may occur in the first distance data and the second distance data.

The noise determination unit 12a can determine whether or not noise occurs, for each piece of the sensor data acquired by the sensor data acquiring unit 11.

For example, the noise determination unit 12a can determine whether or not noise occurs in the first distance data or the second distance data, by using the first machine learning model 301.

As described above, according to the third embodiment, the sensor noise removal device 1b is configured to include: the sensor data acquiring unit 11 that acquires sensor data related to the surrounding situation of the vehicle; the noise determination unit 12a that determines whether or not noise occurs in the sensor data acquired by the sensor data acquiring unit 11, by using the first machine learning model 301 that receives the sensor data as an input and outputs information indicating whether or not noise occurs in the sensor data; and the data replacement unit 13a that acquires, for the sensor data in which it is determined by the noise determination unit 12a that noise occurs, sensor data in which a noise portion of the sensor data has been replaced with sensor data in a state where no noise occurs by using the second machine learning model 302. As a result, the sensor noise removal device 1b can convert the sensor data whose reliability is lowered by noise into the sensor data in a state where no noise occurs.

In the first to third embodiments described above, it is assumed that the camera 21, the lidar 22, and the radar 23 are mounted on the vehicle, and the sensor data in which no noise occurs and which is used at the time of replacement is sensor data acquired from the lidar 22 or the radar 23 mounted on the vehicle. However, this is merely an example.

For example, in the first to third embodiments described above, the sensor data in which no noise occurs and which is used at the time of replacement may be acquired from a device other than the host vehicle, such as another vehicle, the cloud, or a device installed on a road.

In the first to third embodiments described above, it is assumed that the number of sensors of the same type is only one. However, this is merely an example.

For example, a plurality of sensors of the same type may be mounted on the vehicle. As a specific example, for example, two cameras 21, the lidar 22, and the radar 23 may be mounted on the vehicle, and the sensor noise removal devices 1, 1a, and 1b may acquire sensor data from the two cameras 21, the lidar 22, and the radar 23.

In this case, when performing replacement of the sensor data in which noise occurs on the basis of the sensor data in which no noise occurs, the sensor noise removal devices 1, 1a, and 1b preferentially use sensor data of the same type. For example, in a case where noise occurs in a captured image acquired from one camera 21 and no noise occurs in a captured image acquired from the other camera 21, the sensor noise removal devices 1, 1a, and 1b perform replacement of a noise portion of the captured image acquired from the one camera 21 on the basis of the captured image acquired from the other camera 21.

In addition, in the first to third embodiments described above, the sensor noise removal devices 1, 1a, and 1b are in-vehicle devices mounted on the vehicle, and the sensor data acquiring unit 11, the noise determination units 12 and 12a, the data replacement units 13 and 13a, and the output unit 14 are included in the sensor noise removal devices 1, 1a, and 1b. No limitation thereto is intended. A part of the sensor data acquiring unit 11, the noise determination units 12 and 12a, the data replacement units 13 and 13a, and the output unit 14 may be mounted on the in-vehicle device of the vehicle, and the remaining part may be provided in a server connected to the in-vehicle device via a network, so that the in-vehicle device and the server may constitute a sensor noise removal system.

For example, the noise determination units 12 and 12a and the data replacement units 13 and 13a may be provided in the server, and the sensor data acquiring unit 11 and the output unit 14 may be provided in the in-vehicle device. The noise determination units 12 and 12a acquire sensor data from the in-vehicle device. The data replacement units 13 and 13a output after-replacement sensor data to the in-vehicle device.

Note that it is possible to freely combine the embodiments, modify any component of each embodiment, or omit any component of each embodiment in the present disclosure.

### INDUSTRIAL APPLICABILITY

Since the sensor noise removal device according to the present disclosure is configured to be able to convert sensor data whose reliability is lowered by noise into sensor data in a state where no noise occurs, the sensor noise removal device can be applied to a sensor noise removal device mounted on a vehicle or the like that performs processing using sensor data.

### REFERENCE SIGNS LIST

1a, 1b: sensor noise removal device, 21: camera, 22: lidar, 23: radar, 11: sensor data acquiring unit, 12, 12a: noise determination unit, 13a: data replacement unit, 131: replacement possibility determining unit, 14: output unit, 15: sensor DB, 16: noise DB, 17: object detection unit, 18: detection result determining unit, 19: detection result correcting unit, 30: model storage unit, 301: first machine learning model, 302: second machine learning model, 3021: first replacement-function machine learning model, 3022: second replacement-function machine learning model, 3: learning device, 31: data acquisition unit, 311: first model data acquiring unit, 312: first replacement model data acquiring unit, 313: second replacement model data acquiring unit, 32: model generation unit, 321: first model generating unit, 322: first replacement model generating unit, 323: second replacement model generating unit, 601: processing circuit, 602: input interface device, 603: output interface device, 604: CPU, 605: memory

1. A sensor noise removal device comprising:
processing circuitry
to acquire at least one piece of sensor data related to a surrounding situation of a vehicle;
to determine whether or not noise occurs in the sensor data acquired; and
to estimate, for the sensor data in which it is determined that the noise occurs, sensor data in which the noise does not occur, thereby generate replacement data corresponding to a noise portion, and replace the noise portion with the replacement data generated.

2. The sensor noise removal device according to claim 1, wherein
the processing circuitry determines whether or not the noise portion can be replaced in the sensor data in which it is determined that the noise occurs, and
in a case where the processing circuitry determines that the replacement is possible, the processing circuitry replaces the noise portion of the sensor data in which it is determined that the noise occurs with the replacement data.

3. The sensor noise removal device according to claim 1, wherein
the processing circuitry acquires a plurality of pieces of sensor data included in the at least one piece of sensor data, and
the processing circuitry estimates the sensor data in which the noise does not occur on a basis of sensor data in which it is determined that the noise does not occur among the plurality of pieces of sensor data acquired, thereby generates the replacement data, and replaces the noise portion of the sensor data in which it is determined that the noise occurs with the replacement data generated.

4. The sensor noise removal device according to claim 1, wherein the processing circuitry estimates the sensor data in which the noise does not occur on a basis of the sensor data in which it is determined that the noise occurs, thereby generates the replacement data, and replaces the noise portion of the sensor data in which it is determined that the noise occurs with the replacement data generated.

5. The sensor noise removal device according to claim 1, wherein
the sensor data in which it is determined that the noise occurs is a captured image, and
the processing circuitry replaces the noise portion of the captured image in which it is determined that the noise occurs with the replacement data corresponding to the noise portion, the replacement data being generated by estimating a captured image in which the noise does not occur.

6. The sensor noise removal device according to claim 1, wherein the processing circuitry determines whether or not the noise occurs in the sensor data acquired on a basis of characteristics of the sensor data.

7. The sensor noise removal device according to claim 3, wherein
the processing circuitry estimates whether or not an object is detected in the noise portion of the sensor data in which it is determined that the noise occurs, on a basis of the sensor data in which it is determined that the noise does not occur among the plurality of pieces of sensor data acquired, and
in a case of estimating that the object is detected, the processing circuitry generates the replacement data as data that indicates a position of the object, a type of the object, or an orientation of the object.

8. The sensor noise removal device according to claim 1, wherein
the processing circuitry acquires a plurality of pieces of sensor data included in the at least one piece of sensor data,
the processing circuitry detects an object in each of the plurality of pieces of sensor data acquired,
the processing circuitry determines validity of a detection result of the object, and
the processing circuitry corrects the detection result determined to be low in validity to the detection result determined to be high in validity.

9. The sensor noise removal device according to claim 3, wherein the sensor data in which it is determined that the noise does not occur is sensor data acquired from a device other than the vehicle.

10. The sensor noise removal device according to claim 3, wherein a type of the sensor data in which it is determined that the noise does not occur is a same as a type of the sensor data in which it is determined that the noise occurs.

11. A sensor noise removal device comprising:
processing circuitry
to acquire sensor data related to a surrounding situation of a vehicle;
to determine whether or not noise occurs in the sensor data acquired, by using a first machine learning model to receive the sensor data as an input and output information indicating whether or not the noise occurs in the sensor data; and
to acquire, for the sensor data in which it is determined that the noise occurs, sensor data in which a noise portion has been replaced with sensor data in a state where the noise does not occur by using a second machine learning model, the noise portion being included in the sensor data in which it is determined that the noise occurs.

12. The sensor noise removal device according to claim 11, wherein the second machine learning model includes a machine learning model to receive, as inputs, the sensor data in which the noise occurs and sensor data in which the noise does not occur and output the sensor data in which the noise portion of the sensor data in which the noise occurs has been replaced with the sensor data in a state where the noise does not occur.

13. The sensor noise removal device according to claim 11, wherein the second machine learning model includes a machine learning model to receive, as an input, the sensor data in which the noise occurs and output the sensor data in which the noise portion of the sensor data in which the noise occurs has been replaced with the sensor data in a state where the noise does not occur.

14. A sensor noise removal method comprising:
acquiring at least one piece of sensor data related to a surrounding situation of a vehicle;
determining whether or not noise occurs in the sensor data acquired; and
estimating, for the sensor data in which it is determined that the noise occurs, sensor data in which the noise does not occur, thereby generating replacement data corresponding to a noise portion, and replacing the noise portion with the replacement data generated.
